(19) United States
(12) Patent Application Publication
(10) Pub. No.: US 2011/0136994 A1
(43) Pub. Date: Jun. 9, 2011

(54) OLEFIN POLYMERIZATION CATALYST AND PRODUCTION PROCESS OF OLEFIN POLYMER

(75) Inventors: Naoko Ochi, Chiba (JP); Yoshinobu Nozue, Chiba (JP); Yasutoyo Kawashima, Chiba (JP)

(73) Assignee: SUMITOMO CHEMICAL COMPANY, LIMITED, Chuo-ku, Tokyo (JP)

(21) Appl. No.: 12/742,266

(22) PCT Filed: Nov. 27, 2008
(86) PCT No.: PCT/JP2008/071999

§ 371 Date: May 11, 2010

(30) Foreign Application Priority Data
Nov. 30, 2007 (JP) 2007-310078

(51) Int. Cl. C08F 4/76; B01J 31/14

(52) U.S. Cl. 526/118; 502/114

(57) ABSTRACT

An olefin polymerization catalyst is provided formed by contacting a specified transition metal compound (A1), a specified transition metal compound (A2) and a specified solid catalyst component (B) with one another, a molar ratio of (A1)/(A2) being 1 to 90:

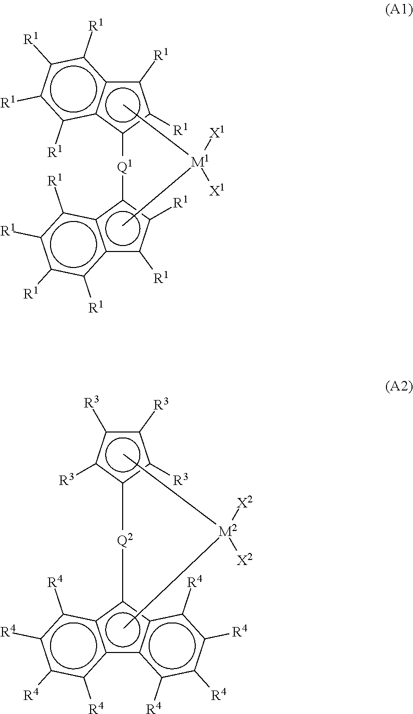

wherein M¹ and M² are a transition metal atom of Group 4 in the Periodic Table; X¹, X², R¹, R³ and R⁴ are a hydrogen atom, a halogen atom, a hydrocarbyl group or a hydrocarbyloxy group; and Q¹ and Q² are a specified cross-linking group.

### TECHNICAL FIELD

The present invention relates to an olefin polymerization catalyst, and a process for producing an olefin polymer.

### BACKGROUND ART

Olefin polymers such as ethylene-α-olefin copolymers are molded into articles such as films, sheets and bottles by various molding methods, and those molded articles are used for various applications such as food packaging materials.

There are known in the art ethylene-α-olefin copolymers produced with a metallocene catalyst, which copolymers are so excellent in their mechanical strength such as impact strength and tensile strength that those copolymers can be expected to give thin-walled molded articles (therefore, lightweight and low-cost molded articles) with maintenance of their mechanical strength, and are investigated in their use for various applications. However, ethylene-α-olefin copolymers produced with a conventional metallocene catalyst have such a large extrusion load under extrusion molding, such a small tensile strength in their melt state and such a small swelling ratio that those copolymers are not sufficient in their molding processability, and are limited in their applications.

On the other hand, new metallocene catalysts have been investigated in recent years, and there are proposed ethylene-α-olefin copolymers, which are produced with those catalyst, and are improved in their molding processability. For example, JP 2003-96125A discloses ethylene-α-olefin copolymers produced with a metallocene catalyst formed from (i) a transition metal compound having ligands in which two cyclopentadiene-containing anionic groups are liked with each other through a cross-linking group, (ii) another transition metal compound having two substituted cyclopentadiene-containing anionic groups, which are not linked with each other, and (iii) a cocatalyst component for activation. Also, JP 2004-149761A discloses ethylene-α-olefin copolymers produced with a metallocene catalyst formed from (i) a cocalyst component formed by contacting silica, hexamethyldisilazane, diethyl zinc, pentafluorophenol and water with one another, (ii) triisobutylaluminum, and (iii) racemic ethylenebis(1-indenyl)zirconium diphenoxide.

However, the above new ethylene-α-olefin copolymers are not satisfactory enough in their molding processability yet.

### DISCLOSURE OF INVENTION

The problem to be solved by the present invention is to provide a catalyst for polymerizing an olefin capable of producing olefin polymers excellent in their mechanical strength and molding processability, and a process for producing an olefin polymer by polymerizing an olefin in the presence of the above catalyst.

In order to solve the above problem, the present inventors have undertaken extensive studies on a production process of olefin polymers excellent in their mechanical strength and molding processability, and as a result, the present invention has been obtained.

Firstly, the present invention relates to an olefin polymerization catalyst formed by contacting a transition metal compound (component (A1)) represented by the following general formula (1), a transition metal compound (component (A2)) represented by the following general formula (3) and the following solid catalyst component (component (B)) with one another, an amount of the component (Al) being 1 to 90 parts by mol per one mol of the component (A2):

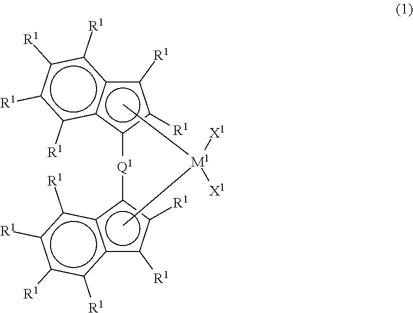

wherein M¹ is a transition metal atom of the group 4 in the periodic table; X¹ and R¹ are independently of each other a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural X¹s are the same as, or different from each other, and plural R¹s are the same as, or different from one another; and Q¹ is a cross-linking group represented by the following general formula (2):

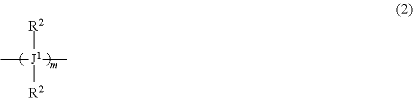

wherein m is an integer of 1 to 5; J¹ is an atom of the group 14 in the periodic table; and R² is a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural R²s are the same as, or different from one another:

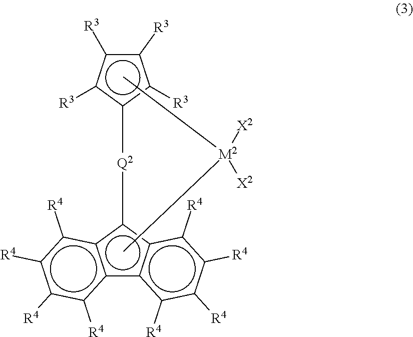

wherein M² is a transition metal atom of the group 4 in the periodic table; X², R³ and R⁴ are independently of one another a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural X²s are the same as, or different from each other, plural R³s are the same as, or different from one another, and plural R⁴s are the same as, or different from one another; and Q² is a cross-linking group represented by the following general formula (4):

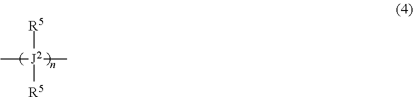

wherein n is an integer of 1 to 5; J² is an atom of the group 14 in the periodic table; and R⁵ is a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural R⁵s are the same as, or different from one another:

component (B) being a solid catalyst component formed by contacting a compound (component (b1)) represented by the following general formula (5), a compound (component (b2)) represented by the following general formula (6), a compound (component (b3)) represented by the following general formula (7), and a granulous carrier (component (b4)):

M³Lₓ (5)

R⁶ₜ₋₁T¹H (6)

R⁷ₛ₋₂T²H₂ (7)

wherein M³ is a lithium atom, a sodium atom, a potassium atom, a rubidium atom, a cesium atom, a beryllium atom, a magnesium atom, a calcium atom, a strontium atom, a barium atom, a zinc atom, a germanium atom, a tin atom, a lead atom, a antimony atom or a bismuth atom; x is a number corresponding to the valence of M³; L is a hydrogen atom, a halogen atom or a hydrocarbyl group optionally having one or more substituents, and when plural Ls exist, they are the same as, or different from one another; T¹ is an oxygen atom, a sulfur atom, a nitrogen atom or a phosphorus atom; t is a number corresponding to the valence of T¹; R⁶ is a halogen atom, an electron-withdrawing group, a halogen atom-containing group, or a group containing an electron-withdrawing group, and when plural R⁶s exist, they are the same as, or different from one another; T² is an oxygen atom, a sulfur atom, a nitrogen atom or a phosphorus atom; s is a number corresponding to the valence of T²; and R⁷ is a halogen atom, a hydrocarbyl group or a halogenated hydrocarbyl group.

Secondly, the present invention relates to an olefin polymerization catalyst described in the above first invention, which is formed by contacting the above components (A1), (A2), (B) and an organoaluminum compound (component (C)) with one another.

Thirdly, the present invention relates to a process for producing an olefin polymer, comprising the step of polymerizing an olefin in the presence of the above olefin polymerization catalyst.

### BEST MODE FOR CARRYING OUT THE INVENTION

In the present invention, the term “polymerization” means not only homopolymerization but also copolymerization, and the term “polymer” means not only homopolymers but also copolymers.

The olefin polymerization catalyst of the present invention is formed by contacting a transition metal compound (component (A1)) represented by the following general formula (1), a transition metal compound (component (A2)) represented by the following general formula (3) and the following solid catalyst component (component (B)) with one another, an amount of the component (A1) being 1 to 90 parts by mol per one mol of the component (A2):

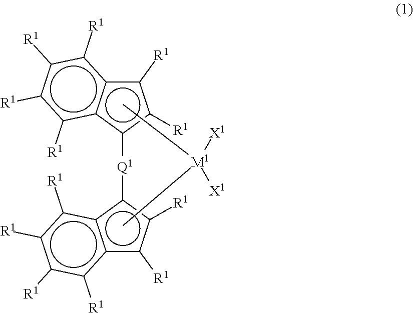

wherein M¹ is a transition metal atom of the group 4 in the periodic table; X¹ and R¹ are independently of each other a hydrogen atom, a halogen atom, a hydrocarbyl group having 1 to carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural X¹s are the same as, or different from each other, and plural R¹s are the same as, or different from one another; and Q¹ is a cross-linking group represented by the following general formula (2):

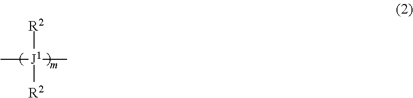

wherein m is an integer of 1 to 5; J¹ is an atom of the group 14 in the periodic table; and R² is a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural R²s are the same as, or different from one another:

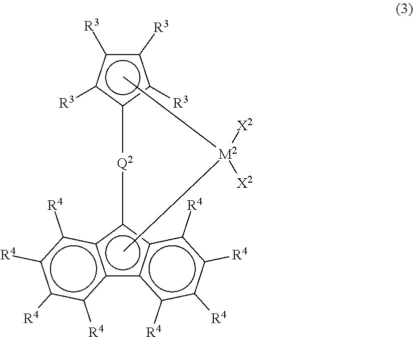

wherein M² is a transition metal atom of the group 4 in the periodic table; X², R³ and R⁴ are independently of one another a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural X²s are the same as, or different from each other, plural R³s are the same as, or different from one another, and plural R⁴s are the same as, or different from one another; and Q² is a cross-linking group represented by the following general formula (4):

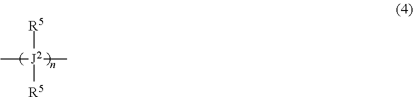

wherein n is an integer of 1 to 5; J² is an atom of the group 14 in the periodic table; and R⁵ is a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural R⁵s are the same as, or different from one another:

component (B) being a solid catalyst component formed by contacting a compound (component (b1)) represented by the following general formula (5), a compound (component (b2)) represented by the following general formula (6), a compound (component (b3)) represented by the following general formula (7), and a granulous carrier (component (b4)):

M³Lₓ (5)

R⁶ₜ₋₁T¹H (6)

R¹ₛ₋₂T²H₂ (7)

wherein M³ is a lithium atom, a sodium atom, a potassium atom, a rubidium atom, a cesium atom, a beryllium atom, a magnesium atom, a calcium atom, a strontium atom, a barium atom, a zinc atom, a germanium atom, a tin atom, a lead atom, a antimony atom or a bismuth atom; x is a number corresponding to the valence of M³; L is a hydrogen atom, a halogen atom or a hydrocarbyl group optionally having one or more substituents, and when plural Ls exist, they are the same as, or different from one another; T¹ is an oxygen atom, a sulfur atom, a nitrogen atom or a phosphorus atom; t is a number corresponding to the valence of T¹; R⁶ is a halogen atom, an electron-withdrawing group, a halogen atom-containing group, or a group containing an electron-withdrawing group, and when plural R⁶s exist, they are the same as, or different from one another; T² is an oxygen atom, a sulfur atom, a nitrogen atom or a phosphorus atom; s is a number corresponding to the valence of T²; and R⁷ is a halogen atom, a hydrocarbyl group or a halogenated hydrocarbyl group.

M¹ in the general formula (1) and M² in the general formula (3) are a transition metal atom of the group 4 in the periodic table. Examples thereof are a titanium atom, a zirconium atom and a hafnium atom.

X¹ and R¹ in the general formula (1) and X², R³ and R⁴ in the general formula (3) are independently of one another a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural X¹s are the same as, or different from each other, plural R¹s are the same as, or different from one another, plural X²s are the same as, or different from each other, plural R³s are the same as, or different from one another, and plural R⁴s are the same as, or different from one another.

Examples of the halogen atom of X¹, R¹, X², R³ R and R⁴ are a fluorine atom, a chlorine atom, a bromine atom and an iodine atom.

Examples of the hydrocarbyl group having 1 to 20 carbon atoms, and optionally having one or more substituents of X¹, R¹,², R³ and R⁴ are alkyl groups having 1 to 20 carbon atoms, halogenated alkyl groups having 1 to 20 carbon atoms, aralkyl groups having 7 to 20 carbon atoms, and aryl groups having 6 to 20 carbon atoms.

Examples of the alkyl groups having 1 to 20 carbon atoms are a methyl group, an ethyl group, a n-propyl group, an isopropyl group, a n-butyl group, a sec-butyl group, a tert-butyl group, a n-pentyl group, a neopentyl group, an isopentyl group, a n-hexyl group, a n-heptyl group, a n-octyl group, a n-decyl group, a n-nonyl group, a n-decyl group, a n-dodecyl group, a n-dodecyl group, a n-tridecyl group, a n-tetradecyl group, a n-pentadecyl group, a n-hexadecyl group, a n-heptadecyl group, a n-octadecyl group, a n-nonadecyl group, and a n-eicodecyl group.

Examples of the halogenated alkyl groups having 1 to 20 carbon atoms are a fluoromethyl group, a difluoromethyl group, a trifluoromethyl group, a chloromethyl group, a dichioromethyl group, a trichioromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchiorobutyl group, a perchloropentyl group, a perchiorohexyl group, a perchlorooctyl group, a perchiorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group, and a perbromoeicosyl group.

Examples of the aralkyl groups having 7 to 20 carbon atoms are a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (4,6-dimethylphenyl)methyl group, a (2,3,4-trimethylphenyl)methyl group, a (2,3,5-trimethylphenyl)methyl group, a (2,3,6-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, a (n-propylphenyl)methyl group, an (isopropylphenyl)methyl group, a (n-butylphenyl)methyl group, a (sec-butylphenyl)methyl group, a (tert-butylphenyl)methyl group, a (n-pentylphenyl)methyl group, a (neopentylphenyl)methyl group, a (n-hexylphenyl)methyl group, a (n-octylphenyl)methyl group, a (n-decylphenyl)methyl group, a (n-decylphenyl)methyl group, a (n-tetradecylphenyl)methyl group, a naphthylmethyl group, an anthracenylmethyl group, a phenylethyl group, a phenylpropyl group, a phenylbutyl group, a diphenylmethyl group, a diphenylethyl group, a diphenylpropyl group, and a diphenylbutyl group; and halogenated aralkyl groups obtained by substituting the above aralkyl groups with a halogen atom such as a fluorine atom, a chlorine atom, a bromine atom and an iodine atom.

Examples of the aryl groups having 6 to 20 carbon atoms are a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a diethylpheny group, a triethylpheny group, a n-propylphenyl group, an isopropylphenyl group, a n-butylphenyl group, a sec-butylphenyl group, a tert-butylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group and an anthracenyl group; and halogenated aryl groups obtained by substituting the above aryl groups with a halogen atom such as a fluorine atom, a chlorine atom, a bromine atom and an iodine atom.

Examples of the hydrocarbyl group having 1 to 20 carbon atoms and optionally having one or more substituents are hydrocarbyl groups substituted with a substituted silyl group, hydrocarbyl groups substituted with a substituted amino group, and hydrocarbyl groups substituted with a hydrocarbyloxy group.

Examples of the hydrocarbyl groups substituted with a substituted silyl group are a trimethylsilylmethyl group, a trimethylsilylethyl group, a trimethylsilylpropyl group, a trimethylsilylbutyl group, a trimethylsilylphenyl group, a bis(trimethylsilyl)methyl group, a bis(trimethylsilyl)ethyl group, a bis(trimethylsilyl)propyl group, a bis(trimethylsilyl)butyl group, a bis(trimethylsilyl)phenyl group, and a triphenylsilylmethyl group.

Examples of the hydrocarbyl groups substituted with a substituted amino group are a dimethylaminomethyl group, a dimethylaminoethyl group, a dimethylaminopropyl group, a dimethylaminobutyl group, a dimethylaminophenyl group, a bis(dimethylamino)methyl group, a bis(dimethylamino)ethyl group, a bis(dimethylamino)propyl group, a bis(dimethylamino)butyl group, a bis(dimethylamino)phenyl group, a phenylaminomethyl group, a diphenylaminomethyl group, and a diphenylaminophenyl group.

Examples of the hydrocarbyl groups substituted with a hydrocarbyloxy group are a methoxymethyl group, an ethoxymethyl group, a n-propoxymethyl group, an isopropoxymethyl group, a n-butoxymethyl group, a sec-butoxymethyl group, a tert-butoxymethyl group, a phenoxymethyl group, a methoxyethyl group, an ethoxyethyl group, a n-propoxyethyl group, an isopropoxyethyl group, a n-butoxyethyl group, a sec-butoxyethyl group, a tert-butoxyethyl group, a phenoxyethyl group, a methoxy-n-propyl group, an ethoxy-n-propyl group, a propoxy-n-propyl group, an isopropoxy-n-propyl group, a n-butoxy-n-propyl group, a sec-butoxy-n-propyl group, a tert-butoxy-n-propyl group, a phenoxy-n-propyl group, a methoxyisopropyl group, an ethoxyisopropyl group, a n-propoxyisopropyl group, an isopropoxyisopropyl group, a n-butoxyisopropyl group, a sec-butoxyisopropyl group, a tert-butoxyisopropyl group, a phenoxyisopropyl group, a methoxyphenyl group, an ethoxyphenyl group, a n-propoxyphenyl group, an isopropoxyphenyl group, a n-butoxyphenyl group, a sec-butoxyphenyl group, a tert-butoxyphenyl group, and a phenoxyphenyl group.

Examples of the hydrocarbyloxy group having 1 to 20 carbon atoms, and optionally having one or more substituents of X¹, R¹, X², R³ and R⁴ are alkoxy groups having 1 to 20 carbon atoms, aralkyloxy groups having 7 to 20 carbon atoms, and aryloxy groups having 6 to 20 carbon atoms.

Examples of the alkoxy groups having 1 to 20 carbon atoms are a methoxy group, an ethoxy group, a n-propoxy group, an isopropoxy group, a n-butoxy group, a sec-butoxy group, a tert-butoxy group, a n-pentyloxy group, a neopentyloxy group, a n-hexyloxy group, a n-octyloxy group, a n-nonyloxy group, a n-decyloxy group, a n-undecyloxy group, a n-dodecyloxy group, a n-tridecyloxy group, a n-tetradecyloxy group, a n-pentadecyloxy group, a n-hexadecyloxy group, a n-heptadecyloxy group, a n-heptadecyloxy group, a n-octadecyloxy group, a n-nonadecyloxy group, and a n-eicosoxy group; and halogenated alkoxy groups obtained by substituting the above alkoxy groups with a halogen atom such as a fluorine atom, a chlorine atom, a bromine atom and an iodine atom.

Examples of the aralkyloxy groups having 7 to 20 carbon atoms are a benzyloxy group, a (2-methylphenyl)methoxy group, a (3-methylphenyl)methoxy group, a (4-methylphenyl)methoxy group, a (2,3-dimethylphenyl)methoxy group, a (2,4-dimethylphenyl)methoxy group, a (2,5-dimethylphenyl)methoxy group, a (2,6-dimethylphenyl)methoxy group, a (3,4-dimethylphenyl)methoxy group, a (3,5-dimethylphenyl)methoxy group, a (2,3,4-trimethylphenyl)methoxy group, a (2,3,5-trimethylphenyl)methoxy group, a (2,3,6-trimethylphenyl)methoxy group, a (2,4,5-trimethylphenyl)methoxy group, a (2,4,6-trimethylphenyl)methoxy group, a (3,4,5-trimethylphenyl)methoxy group, a (2,3,4,5-tetramethylphenyl)methoxy group, a (2,3,4,6-tetramethylphenyl)methoxy group, a (2,3,5,6-tetramethylphenyl)methoxy group, a (pentamethylphenyl)methoxy group, an (ethylphenyl)methoxy group, a (n-propylphenyl)methoxy group, an (isopropylphenyl)methoxy group, a (n-butylphenyl)methoxy group, a (sec-butylphenyl)methoxy group, a (tert-butylphenyl)methoxy group, a (n-hexylphenyl)methoxy group, a (n-octylphenyl)methoxy group, a (n-decylphenyl)methoxy group, a (n-tetradecylphenyl)methoxy group, a naphthylmethoxy group and an anthracenylmethoxy group; and halogenated aralkyloxy groups obtained by substituting the above aralkyloxy groups with a halogen atom such as a fluorine atom, a chlorine atom, a bromine atom and an iodine atom.

Examples of the aryloxy groups having 6 to 20 carbon atoms are a phenoxy group, a 2-methylphenoxy group, a 3-methylphenoxy group, a 4-methylphenoxy group, a 2,3-dimethylphenoxy group, a 2,4-dimethylphenoxy group, a 2,5-dimethylphenoxy group, a 2,6-dimethylphenoxy group, a 3,4-dimethylphenoxy group, a 3,5-dimethylphenoxy group, a 2,3,4-trimethylphenoxy group, a 2,3,5-trimethylphenoxy group, a 2,3,6-trimethylphenoxy group, a 2,4,5-trimethylphenoxy group, a 2,4,6-trimethylphenoxy group, a 3,4,5-trimethylphenoxy group, a 2,3,4,5-tetramethylphenoxy group, a 2,3,4,6-tetramethylphenoxy group, a 2,3,5,6-tetramethylphenoxy group, a pentamethylphenoxy group, an ethylphenoxy group, a n-propylphenoxy group, an isopropylphenoxy group, a n-butylphenoxy group, a sec-butylphenoxy group, a tert-butylphenoxy group, a n-hexylphenoxy group, a n-octylphenoxy group, a n-decylphenoxy group, a n-tetradecylphenoxy group, a naphthoxy group and an anthracenoxy group; and halogenated aryloxy groups obtained by substituting the above aryloxy groups with a halogen atom such as a fluorine atom, a chlorine atom, a bromine atom and an iodine atom.

Examples of the substituted silyl group having 1 to 20 carbon atoms of X¹, R¹, X², R³ and R⁴ are silyl groups substituted with a hydrocarbyl group such as an alkyl group and an aryl group. Specific examples thereof are mono-substituted silyl groups such as a methylsilyl group, an ethylsilyl group, a n-propylsilyl group, an isopropylsilyl group, a n-butylsilyl group, a sec-butylsilyl group, a tert-butylsilyl group, an isobutylsilyl group, a n-pentylsilyl group, a n-hexylsilyl group, and a phenylsilyl group; di-substituted silyl groups such as a dimethylsilyl group, a diethylsilyl group, a di-n-propylsilyl group, a diisopropylsilyl group, a di-n-butylsilyl group, a di-sec-butylsilyl group, a di-tert-butylsilyl group, a diisobutylsilyl group, and a diphenylsilyl group; and tri-substituted silyl groups such as a trimethylsilyl group, a triethylsilyl group, a tri-n-propylsilyl group, a triisopropylsilyl group, a tri-n-butylsilyl group, a tri-sec-butylsilyl group, a tri-tert-butylsilyl group, a triisobutylsilyl group, a tert-butyl-dimethylsilyl group, a tri-n-pentylsilyl group, a tri-n-hexylsilyl group, a tricyclohexylsilyl group, and a triphenylsilyl group.

Examples of the substituted amino group having 1 to 20 carbon atoms of X¹, R¹, X², R³ and R⁴ are amino groups substituted with two of a hydrocarbyl group such as an alkyl group and an aryl group. Specific examples thereof are a methylamino group, an ethylamino group, a n-propylamino group, an isopropylamino group, a n-butylamino group, a sec-butylamino group, a tert-butylamino group, an isobutylamino group, a n-hexylamino group, a n-octylamino group, a n-decylamino group, a phenylamino group, a benzylamino group, a dimethylamino group, a diethylamino group, a di-n-propylamino group, a diisopropylamino group, a di-n-butylamino group, a di-sec-butylamino group, a di-tert-butylamino group, a diisobutylamino group, a tert-butylisopropylamino group, a di-n-hexylamino group, a di-n-octylamino group, a di-n-decylamino group, a diphenylamino group, a dibenzylamino group, a tert-butylisopropylamino group, a phenylethylamino group, a phenylpropylamino group, a phenylbutylamino group, a pyrrolyl group, a pyrrolidinyl group, a piperidinyl group, a carbazolyl group, and a dihydroisoindolyl group.

X¹ is preferably a chlorine atom, a methyl group, an ethyl group, a n-propyl group, an isopropyl group, a n-butyl group, a methoxy group, an ethoxy group, a n-propoxy group, an isopropoxy group, a n-butoxy group, a trifluoromethoxy group, a phenyl group, a phenoxy group, a 2,6-di-tert-butylphenoxy group, a 3,4,5-trifluorophenoxy group, a pentafluorophenoxy group, a 2,3,5,6-tetrafluoro-4-pentafluorophenylphenoxy group or a benzyl group.

R¹ is preferably a hydrogen atom or an alkyl group having 1 to 6 carbon atoms, more preferably a hydrogen atom or an alkyl group having 1 to 4 carbon atoms, and further preferably a hydrogen atom.

X² is preferably a chlorine atom, a methyl group, an ethyl group, a n-propyl group, an isopropyl group, a n-butyl group, a methoxy group, an ethoxy group, a n-propoxy group, an isopropoxy group, a n-butoxy group, a trifluoromethoxy group, a phenyl group, a phenoxy group, a 2,6-di-tert-butylphenoxy group, a 3,4,5-trifluorophenoxy group, a pentafluorophenoxy group, a 2,3,5,6-tetrafluoro-4-pentafluorophenylphenoxy group or a benzyl group.

R³ is preferably a hydrogen atom or an alkyl group having 1 to 6 carbon atoms, more preferably a hydrogen atom or an alkyl group having 1 to 4 carbon atoms, and further preferably a hydrogen atom.

R⁴ is preferably a hydrogen atom or an alkyl group having 1 to 6 carbon atoms, more preferably a hydrogen atom or an alkyl group having 1 to 4 carbon atoms, and further preferably a hydrogen atom.

Q¹ in the general formula (1) is a cross-linking group represented by the general formula (2), and Q² in the general formula (3) is a cross-linking group represented by the general formula (4).

m in the general formula (2) and n in the general formula (4) are an integer of 1 to 5. m is preferably 1 or 2. n is preferably 1 or 2.

J¹ in the general formula (2) and J² in the general formula (4) are an atom of the group 14 in the periodic table. They are preferably a carbon atom or a silicon atom.

R² in the general formula (2) and R⁵ in the general formula (4) are independently of each other a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural R²s are the same as, or different from one another, and plural R⁵s are the same as, or different from one another.

Examples of the halogen atom of R² and R⁵, examples of the hydrocarbyl group having 1 to 20 carbon atoms, and optionally having one or more substituents thereof, examples of the hydrocarbyloxy group having 1 to 20 carbon atoms, and optionally having one or more substituents thereof, examples of the substituted silyl group having 1 to 20 carbon atoms thereof, and examples of the substituted amino group having 1 to 20 carbon atoms thereof are those, respectively, exemplified as the halogen atom of X¹, R¹, X², R³ and R⁴, exemplified as the hydrocarbyl group having 1 to 20 carbon atoms, and optionally having one or more substituents thereof, exemplified as the hydrocarbyloxy group having 1 to 20 carbon atoms, and optionally having one or more substituents thereof, exemplified as the substituted silyl group having 1 to 20 carbon atoms thereof, and exemplified as the substituted amino group having 1 to 20 carbon atoms thereof.

Examples of Q¹ and Q² are a methylene group, an ethylidene group, an ethylene group, a propylidene group, a propylene group, a butylidene group, a butylene group, a pentylidene group, a pentylene group, a hexylidene group, an isopropylidene group, a methylethylmethylene group, a methylpropylmethylene group, a methylbutylmethylene group, a bis(cyclohexyl)methylene group, a methylphenylmethylene group, a diphenylmethylene group, a phenyl(methylphenyl)methylene group, a di(methylphenyl)methylene group, a bis(dimethylphenyl)methylene group, a bis(trimethylphenyl)methylene group, a phenyl(ethylphenyl)methylene group, a di(ethylphenyl)methylene group, a bis(diethylphenyl)methylene group, a phenyl(propylphenyl)methylene group, a di(propylphenyl)methylene group, a bis(dipropylphenyl)methylene group, a phenyl(butylphenyl)methylene group, a di(butylphenyl)methylene group, a phenyl(naphthyl)methylene group, a di(naphthyl)methylene group, a phenyl(biphenyl)methylene group, a di(biphenyl)methylene group, a phenyl(trimethylsilylphenyl)methylene group, a bis(trimethylsilylphenyl)methylene group, a bis(pentafluorophenyl)methylene group, a silanediyl group, a disilanediyl group, a trisilanediyl group, a tetrasilanediyl group, a dimethylsilanediyl group, a bis(dimethylsilane)diyl group, a diethylsilanediyl group, a dipropylsilanediyl group, a dibutylsilanediyl group, a diphenylsilanediyl group, a silacyclobutanediyl group, a silacyclohexanediyl group, a divinylsilanediyl group, a diallylsilanediyl group, a (methyl)(vinyl)silanediyl group, and an (allyl)(methyl)silanediyl group.

Q¹ is preferably a methylene group, an ethylene group, an isopropylidene group, a bis(cyclohexyl)methylene group, a diphenylmethylene group, a dimethylsilanediyl group, or a bis(dimethylsilane)diyl group, and more preferably an ethylene group or a dimethylsilanediyl group. Q² is preferably a methylene group, an ethylene group, an isopropylidene group, a bis(cyclohexyl)methylene group, a diphenylmethylene group, a dimethylsilanediyl group, or a bis(dimethylsilane)diyl group, and more preferably a diphenylmethylene group.

Examples of the transition metal compound (component (A1)) represented by the general formula (1), in case that M¹ is a zirconium atom and X¹ is a chlorine atom, are methylenebis(indenyl)zirconium dichloride, isopropylidenebis(indenyl)zirconium dichloride, (methyl)(phenyl)methylenebis(indenyl)zirconium dichloride, diphenylmethylenebis(indenyl)zirconium dichloride, ethylenebis(indenyl)zirconium dichloride, methylenebis(methylindenyl)zirconium dichloride, isopropylidenebis(methylindenyl)zirconium dichloride, (methyl)(phenyl)methylenebis(methylindenyl)zirconium dichloride, diphenylmethylenebis(methylindenyl)zirconium dichloride, ethylenebis(methylindenyl)zirconium dichloride, methylene(indenyl)(methylindenyl)zirconium dichloride, isopropylidene(indenyl)(methylindenyl)zirconium dichloride, (methyl)(phenyl)methylene(indenyl)(methylindenyl)zirconium dichloride, diphenylmethylene(indenyl)(methylindenyl)zirconium dichloride, ethylene(indenyl)(methylindenyl)zirconium dichloride, methylenebis(2,4-dimethylindenyl)zirconium dichloride, isopropylidenebis(2,4-dimethylindenyl)zirconium dichloride, (methyl)(phenyl)methylenebis(2,4-dimethylindenyl)zirconium dichloride, diphenylmethylenebis(2,4-dimethylindenyl)zirconium dichloride, ethylenebis(2,4-dimethylindenyl)zirconium dichloride, dimethylsilanediylbis(indenyl)zirconium dichloride, diethylsilanediylbis(indenyl)zirconium dichloride, di(n-propyl)silanediylbis(indenyl)zirconium dichloride, diisopropylsilanediylbis(indenyl)zirconium dichloride, dicyclohexylsilanediylbis(indenyl)zirconium dichloride, diphenylsilanediylbis(indenyl)zirconium dichloride, di(p-tolyl)silanediylbis(indenyl)zirconium dichloride, divinylsilanediylbis(indenyl)zirconium dichloride, diallylsilanediylbis(indenyl)zirconium dichloride, (methyl)(vinyl)silanediylbis(indenyl)zirconium dichloride, (allyl)(methyl)silanediylbis(indenyl)zirconium dichloride, (ethyl)(methyl)silanediylbis(indenyl)zirconium dichloride, (methyl)(n-propyl)silanediylbis(indenyl)zirconium dichloride, (methyl)(isopropyl)silanediylbis(indenyl)zirconium dichloride, (cyclohexyl)(methyl)bis(indenyl)zirconium dichloride, (methyl)(phenyl)silanediylbis(indenyl)zirconium dichloride, dimethylsilanediylbis(methylindenyl)zirconium dichloride, diethylsilanediylbis(methylindenyl)zirconium dichloride, di(n-propyl)silanediylbis(methylindenyl)zirconium dichloride, diisopropylsilanediylbis(methylindenyl)zirconium dichloride, dicyclohexylsilanediylbis(methylindenyl)zirconium dichloride, diphenylsilanediylbis(methylindenyl)zirconium dichloride, (ethyl)(methyl)silanediylbis(methylindenyl)zirconium dichloride, (methyl)(n-propyl)silanediylbis(methylindenyl)zirconium dichloride, (methyl)(isopropyl)silanediylbis(methylindenyl)zirconium dichloride, (cyclohexyl)(methyl)bis(methylindenyl)zirconium dichloride, (methyl)(phenyl)silanediylbis(methylindenyl)zirconium dichloride, dimethylsilanediyl(indenyl)(methylindenyl)zirconium dichloride, diethylsilanediyl(indenyl)(methylindenyl)zirconium dichloride, di(n-propyl)silanediyl(indenyl)(methylindenyl)zirconium dichloride, diisopropylsilanediyl(indenyl)(methylindenyl)zirconium dichloride, dicyclohexylsilanediyl(indenyl)(methylindenyl)zirconium dichloride, diphenylsilanediyl(indenyl)(methylindenyl)zirconium dichloride, (ethyl)(methyl)silanediyl(indenyl)(methylindenyl)zirconium dichloride, (methyl)(n-propyl)silanediyl(indenyl)(methylindenyl)zirconium dichloride, (methyl)(isopropyl)silanediyl(indenyl)(methylindenyl)zirconium dichloride, (cyclohexyl)(methyl)(indenyl)(methylindenyl)zirconium dichloride, (methyl)(phenyl)silanediyl(indenyl)(methylindenyl)zirconium dichloride, dimethylsilanediylbis(2,4-dimethylindenyl)zirconium dichloride, diethylsilanediylbis(2,4-dimethylindenyl)zirconium dichloride, di(n-propyl)silanediylbis(2,4-dimethylindenyl)zirconium dichloride, diisopropylsilanediylbis(2,4-dimethylindenyl)zirconium dichloride, dicyclohexylsilanediylbis(2,4-dimethylindenyl)zirconium dichloride, diphenylsilanediylbis(2,4-dimethylindenyl)zirconium dichloride, (ethyl)(methyl)silanediylbis(2,4-dimethylindenyl)zirconium dichloride, (methyl)(n-propyl)silanediylbis(2,4⁻dimethylindenyl) zirconium dichloride, (methyl)(isopropyl)silanediylbis(2,4-dimethylindenyl) zirconium dichloride, (cyclohexyl)(methyl)bis(2,4-dimethylindenyl)zirconium dichloride, and (methyl)(phenyl)silanediylbis(2,4-dimethylindenyl)zirconium dichloride.

Regarding the above exemplification, when the cross-linking group is present at 1-position, a substituent position of the η⁵-indenyl group, in the case of mono-substitution, contains 2-position, 3-position, 4-position, 5-position, 6-position and 7-position, and similarly to the above, when the cross-linking group is present at other position than 1-position, a substituent position of the η⁵-indenyl group contains all positions except the position substituted by the cross-linking group. Similarly, substituent positions of a di- or multi-substitution contain all combinations of substituent positions except the position substituted by the cross-linking group. Also, examples of the transition metal compound (component (A1)) represented by the general formula (1) are compounds obtained by changing “dichloride” (two X¹s) in the above-exemplified transition metal compounds to “difluoride”, “dibromide”, “diiodide”, “dimethyl”, “diethyl”, “diisopropyl”, “dimethoxide”, “diethoxide”, “dipropoxide”, “dibutoxide”, “bis(trifluoromethoxide)”, “diphenyl”, “diphenoxide”, “bis(2,6-di-tert-butylphenoxide)”, “bis(3,4,5-trifluorophenoxide)”, “bis(pentafluorophenoxide)”, “bis(2,3,5,6-tetrafluoro-4-pentafluorophenylphenoxide)”, or “dibenzyl”. Further examples thereof are compounds obtained by changing “zirconium” (M¹) in the above-exemplified transition metal compounds to “titanium” or “hafnium”.

The transition metal compound (component (A1)) represented by the general formula (1) is preferably ethylenebis(indenyl)zirconium diphenoxide, ethylenebis(indenyl)zirconium dichloride, or dimethylsilylenebis(indenyl)zirconium dichloride.

Examples of the transition metal compound (component (A2)) represented by the general formula (3), in case that M² is a zirconium atom, X² is a chlorine atom, and the cross-linking group Q² is a diphenylmethylene group, are diphenylmethylene(1-cyclopentadienyl)(9-fluorenyl)zirconium dichloride, diphenylmethylene(2-methyl-1-cyclopentadienyl)(9-fluorenyl)zirconium dichloride, diphenylmethylene(3-methyl-1-cyclopentadienyl)(9-fluorenyl)zirconium dichloride, diphenylmethylene(2,4-dimethyl-1-cyclopentadienyl)(9-fluorenyl)zirconium dichloride, diphenylmethylene(2,5-dimethyl-1-cyclopentadienyl)(9-fluorenyl)zirconium dichloride, diphenylmethylene(3,4-dimethyl-1-cyclopentadienyl)(9-fluorenyl)zirconium dichloride, diphenylmethylene(2,3,4-trimethyl-1-cyclopentadienyl)(9-fluorenyl)zirconium dichloride, diphenylmethylene(2,3,5-trimethyl-1-cyclopentadienyl)(9-fluorenyl)zirconium dichloride, diphenylmethylene(3,4,5-trimethyl-1-cyclopentadienyl)(9-fluorenyl)zirconium dichloride, diphenylmethylene(2,3,4,5-tetramethyl-1-cyclopentadienyl)(9-fluorenyl)zirconium dichloride, diphenylmethylene(2-ethyl-1-cyclopentadienyl)(9-fluorenyl)zirconium dichloride, diphenylmethylene(3-ethyl-1-cyclopentadienyl)(9-fluorenyl)zirconium dichloride, diphenylmethylene(2,4-diethyl-1-cyclopentadienyl)(9-fluorenyl)zirconium dichloride, diphenylmethylene(2,5-diethyl-1-cyclopentadienyl)(9-fluorenyl)zirconium dichloride, diphenylmethylene(3,4-diethyl-1-cyclopentadienyl)(9-fluorenyl)zirconium dichloride, diphenylmethylene(2,3,4-triethyl-1-cyclopentadienyl) (9-fluorenyl)zirconium dichloride, diphenylmethylene(2,3,5-triethyl-1-cyclopentadienyl)(9-fluorenyl)zirconium dichloride, diphenylmethylene(3,4,5-triethyl-1-cyclopentadienyl)(9-fluorenyl)zirconium dichloride, diphenylmethylene(2,3,4,5-tetraethyl-1-cyclopentadienyl)(9-fluorenyl)zirconium dichloride, diphenylmethylene(2-n-propyl-1-cyclopentadienyl)(9-fluorenyl)zirconium dichloride, diphenylmethylene(3-n-propyl-1-cyclopentadienyl)(9-fluorenyl)zirconium dichloride, diphenylmethylene(2,4-di-n-propyl-1-cyclopentadienyl)(9-fluorenyl)zirconium dichloride, diphenylmethylene(2,5-di-n-propyl-1-cyclopentadienyl)(9-fluorenyl)zirconium dichloride, diphenylmethylene(3,4-di-n-propyl-1-cyclopentadienyl)(9-fluorenyl)zirconium dichloride, diphenylmethylene(2,3,4-tri-n-propyl-1-cyclopentadienyl)(9-fluorenyl)zirconium dichloride, diphenylmethylene(2,3,5-tri-n-propyl-1-cyclopentadienyl)(9-fluorenyl)zirconium dichloride, diphenylmethylene(3,4,5-tri-n-propyl-1-cyclopentadienyl)(9-fluorenyl)zirconium dichloride, diphenylmethylene(2,3,4,5-tetra-n-propyl-1-cyclopentadienyl)(9-fluorenyl)zirconium dichloride, diphenylmethylene(2-isopropyl-1-cyclopentadienyl)(9-fluorenyl)zirconium dichloride, diphenylmethylene(3-isopropyl-1-cyclopentadienyl)(9-fluorenyl)zirconium dichloride, diphenylmethylene(2,4-diisopropyl-1-cyclopentadienyl)(9-fluorenyl)zirconium dichloride, diphenylmethylene(2,5-diisopropyl-1-cyclopentadienyl)(9-fluorenyl)zirconium dichloride, diphenylmethylene(3,4-diisopropyl-1-cyclopentadienyl)(9-fluorenyl)zirconium dichloride, diphenylmethylene(2,3,4-triisopropyl-1-cyclopentadienyl)(9-fluorenyl)zirconium dichloride, diphenylmethylene(2,3,5-triisopropyl-1-cyclopentadienyl)(9-fluorenyl)zirconium dichloride, diphenylmethylene(3,4,5-triisopropyl-1-cyclopentadienyl)(9-fluorenyl)zirconium dichloride, diphenylmethylene(2,3,4,5-tetraisopropyl-1-cyclopentadienyl)(9-fluorenyl)zirconium dichloride, diphenylmethylene(2-phenyl-1-cyclopentadienyl)(9-fluorenyl)zirconium dichloride, diphenylmethylene(3-phenyl-1-cyclopentadienyl)(9-fluorenyl)zirconium dichloride, diphenylmethylene(2,4-diphenyl-1-cyclopentadienyl)(9-fluorenyl)zirconium dichloride, diphenylmethylene(2,5-diphenyl-1-cyclopentadienyl)(9-fluorenyl)zirconium dichloride, diphenylmethylene(3,4-diphenyl-1-cyclopentadienyl)(9-fluorenyl)zirconium dichloride, diphenylmethylene(2,3,4-triphenyl-1-cyclopentadienyl)(9-fluorenyl)zirconium dichloride, diphenylmethylene(2,3,5-triphenyl-1-cyclopentadienyl)(9-fluorenyl)zirconium dichloride, diphenylmethylene(3,4,5-triphenyl-1-cyclopentadienyl)(9-fluorenyl)zirconium dichloride, diphenylmethylene(2,3,4,5-tetraphenyl-1-cyclopentadienyl)(9-fluorenyl)zirconium dichloride, diphenylmethylene(2-trimethylsilyl-1-cyclopentadienyl)(9-fluorenyl)zirconium dichloride, diphenylmethylene(3-trimethylsilyl-1-cyclopentadienyl)(9-fluorenyl)zirconium dichloride, diphenylmethylene(2,4-bis(trimethylsilyl)-1-cyclopentadienyl)(9-fluorenyl)zirconium dichloride, diphenylmethylene(2,5-bis(trimethylsilyl)-1-cyclopentadienyl)(9-fluorenyl)zirconium dichloride, diphenylmethylene(3,4-bis(trimethylsilyl)-1-cyclopentadienyl)(9-fluorenyl)zirconium dichloride, diphenylmethylene(2,3,4-tris(trimethylsilyl)-1-cyclopentadienyl)(9-fluorenyl)zirconium dichloride, diphenylmethylene(2,3,5-tris (trimethylsilyl) -1-cyclopentadienyl)(9-fluorenyl)zirconium dichloride, diphenylmethylene(3,4,5-tris (trimethylsilyl)-1-cyclopentadienyl)(9-fluorenyl)zirconium dichloride, diphenylmethylene(2,3,4,5-tetrakis(trimethylsilyl)-1-cyclopentadienyl)(9-fluorenyl)zirconium dichloride, diphenylmethylene(1-cyclopentadienyl)(2,7-dimethyl-9-fluorenyl)zirconium dichloride, diphenylmethylene(2-methyl-1-cyclopentadienyl)(2,7-dimethyl-9-fluorenyl)zirconium dichloride, diphenylmethylene(3-methyl-1-cyclopentadienyl)(2,7-dimethyl-9-fluorenyl)zirconium dichloride, diphenylmethylene(2,4-dimethyl-1-cyclopentadienyl)(2,7-dimethyl-9-fluorenyl)zirconium dichloride, diphenylmethylene(2,5-dimethyl-1-cyclopentadienyl)(2,7-dimethyl-9-fluorenyl)zirconium dichloride, diphenylmethylene(3,4-dimethyl-1-cyclopentadienyl)(2,7-dimethyl-9-fluorenyl)zirconium dichloride, diphenylmethylene(2,3,4-trimethyl-1-cyclopentadienyl)(2,7-dimethyl-9-fluorenyl)zirconium dichloride, diphenylmethylene(2,3,5-trimethyl-1-cyclopentadienyl)(2,7-dimethyl-9-fluorenyl)zirconium dichloride, diphenylmethylene(3,4,5-trimethyl-1-cyclopentadienyl)(2,7-dimethyl-9-fluorenyl)zirconium dichloride, diphenylmethylene(2,3,4,5-tetramethyl-1-cyclopentadienyl)(2,7-dimethyl-9-fluorenyl)zirconium dichloride, diphenylmethylene(2-ethyl-1-cyclopentadienyl)(2,7-dimethyl-9-fluorenyl)zirconium dichloride, diphenylmethylene(3-ethyl-1-cyclopentadienyl)(2,7-dimethyl-9-fluorenyl)zirconium dichloride, diphenylmethylene(2,4-diethyl-1-cyclopentadienyl)(2,7-dimethyl-9-fluorenyl)zirconium dichloride, diphenylmethylene(2,5-diethyl-1-cyclopentadienyl)(2,7-dimethyl-9-fluorenyl)zirconium dichloride, diphenylmethylene(3,4-diethyl-1-cyclopentadienyl)(2,7-dimethyl-9-fluorenyl)zirconium dichloride, diphenylmethylene(2,3,4-triethyl-1-cyclopentadienyl)(2,7-dimethyl-9-fluorenyl)zirconium dichloride, diphenylmethylene(2,3,5-triethyl-1-cyclopentadienyl)(2,7-dimethyl-9-fluorenyl)zirconium dichloride, diphenylmethylene(3,4,5-triethyl-1-cyclopentadienyl)(2,7-dimethyl-9-fluorenyl)zirconium dichloride, diphenylmethylene(2,3,4,5-tetraethyl-1-cyclopentadienyl)(2,7-dimethyl-9-fluorenyl)zirconium dichloride, diphenylmethylene(2-n-propyl-1-cyclopentadienyl)(2,7-dimethyl-9-fluorenyl)zirconium dichloride, diphenylmethylene(3-n-propyl-1-cyclopentadienyl)(2,7-dimethyl-9-fluorenyl)zirconium dichloride, diphenylmethylene(2,4-di-n-propyl-1-cyclopentadienyl)(2,7-dimethyl-9-fluorenyl)zirconium dichloride, diphenylmethylene(2,5-di-n-propyl-1-cyclopentadienyl)(2,7-dimethyl-9-fluorenyl)zirconium dichloride, diphenylmethylene(3,4-di-n-propyl-1-cyclopentadienyl)(2,7-dimethyl-9-fluorenyl)zirconium dichloride, diphenylmethylene(2,3,4-tri-n-propyl-1-cyclopentadienyl)(2,7-dimethyl-9-fluorenyl)zirconium dichloride, diphenylmethylene(2,3,5-tri-n-propyl-1-cyclopentadienyl)(2,7-dimethyl-9-fluorenyl)zirconium dichloride, diphenylmethylene(3,4,5-tri-n-propyl-1-cyclopentadienyl)(2,7-dimethyl-9-fluorenyl)zirconium dichloride, diphenylmethylene(2,3,4,5-tetra-n-propyl-1-cyclopentadienyl)(2,7-dimethyl-9-fluorenyl)zirconium dichloride, diphenylmethylene(2-isoropyl-1-cyclopentadienyl)(2,7-dimethyl-9-fluorenyl)zirconium dichloride, diphenylmethylene(3-isoropyl-1-cyclopentadienyl)(2,7-dimethyl-9-fluorenyl)zirconium dichloride, diphenylmethylene(2,4-diisopropyl-1-cyclopentadienyl)(2,7-dimethyl-9-fluorenyl)zirconium dichloride, diphenylmethylene(2,5-diisopropyl-1-cyclopentadienyl)(2,7-dimethyl-9-fluorenyl)zirconium dichloride, diphenylmethylene(3,4-diisopropyl-1-cyclopentadienyl)(2,7-dimethyl-9-fluorenyl)zirconium dichloride, diphenylmethylene(2,3,4-triisopropyl-1-cyclopentadienyl)(2,7-dimethyl-9-fluorenyl)zirconium dichloride, diphenylmethylene(2,3,5-triisopropyl-1-cyclopentadienyl)(2,7-dimethyl-9-fluorenyl)zirconium dichloride, diphenylmethylene(3,4,5-triisopropyl-1-cyclopentadienyl)(2,7-dimethyl-9-fluorenyl)zirconium dichloride, diphenylmethylene(2,3,4,5-tetraisopropyl-1-cyclopentadienyl)(2,7-dimethyl-9-fluorenyl)zirconium dichloride, diphenylmethylene(2-phenyl-1-cyclopentadienyl)(2,7-dimethyl-9-fluorenyl)zirconium dichloride, diphenylmethylene(3-phenyl-1-cyclopentadienyl)(2,7-dimethyl-9-fluorenyl)zirconium dichloride, diphenylmethylene(2,4-dipheyl-1-cyclopentadienyl)(2,7-dimethyl-9-fluorenyl)zirconium dichloride, diphenylmethylene(2,5-diphenyl-1-cyclopentadienyl)(2,7-dimethyl-9-fluorenyl)zirconium dichloride, diphenylmethylene(3,4-diphenyl-1-cyclopentadienyl)(2,7-dimethyl-9-fluorenyl)zirconium dichloride, diphenylmethylene(2,3,4-triphenyl-1-cyclopentadienyl)(2,7-dimethyl-9-fluorenyl)zirconium dichloride, diphenylmethylene(2,3,5-triphenyl-1-cyclopentadienyl)(2,7-dimethyl-9-fluorenyl)zirconium dichloride, diphenylmethylene(3,4,5-triphenyl-1-cyclopentadienyl)(2,7-dimethyl-9-fluorenyl)zirconium dichloride, diphenylmethylene(2,3,4,5-tetraphenyl-1-cyclopentadienyl)(2,7-dimethyl-9-fluorenyl)zirconium dichloride, diphenylmethylene(2-trimethylsilyl-1-cyclopentadienyl)(2,7-dimethyl-9-fluorenyl)zirconium dichloride, diphenylmethylene(3-trimethylsilyl-1-cyclopentadienyl)(2,7-dimethyl-9-fluorenyl)zirconium dichloride, diphenylmethylene(2,4-bis(trimethylsilyl)-1-cyclopentadienyl)(2,7-dimethyl-9-fluorenyl)zirconium dichloride, diphenylmethylene(2,5-bis(trimethylsilyl)-1-cyclopentadienyl)(2,7-dimethyl-9-fluorenyl)zirconium dichloride, diphenylmethylene(3,4-bis(trimethylsilyl)-1-cyclopentadienyl)(2,7-dimethyl-9-fluorenyl)zirconium dichloride, diphenylmethylene(2,3,4-tris(trimethylsilyl)-1-cyclopentadienyl)(2,7-dimethyl-9-fluorenyl)zirconium dichloride, diphenylmethylene(2,3,5-tris(trimethylsilyl)-1-cyclopentadienyl)(2,7-dimethyl-9-fluorenyl)zirconium dichloride, diphenylmethylene(3,4,5-tris(trimethylsilyl)-1-cyclopentadienyl)(2,7-dimethyl-9-fluorenyl)zirconium dichloride, diphenylmethylene(2,3,4,5-tetrakis(trimethylsilyl)-1-cyclopentadienyl)(2,7-dimethyl-9-fluorenyl)zirconium dichloride, diphenylmethylene(1-cyclopentadienyl)(2,7-diethyl-9-fluorenyl)zirconium dichloride, diphenylmethylene(2-methyl-1-cyclopentadienyl)(2,7-diethyl-9-fluorenyl)zirconium dichloride, diphenylmethylene(3-methyl-1-cyclopentadienyl)(2,7-diethyl-9-fluorenyl)zirconium dichloride, diphenylmethylene(2,4-dimethyl-1-cyclopentadienyl)(2,7-diethyl-9-fluorenyl)zirconium dichloride, diphenylmethylene(2,5-dimethyl-1-cyclopentadienyl)(2,7-diethyl-9-fluorenyl)zirconium dichloride, diphenylmethylene(3,4-dimethyl-1-cyclopentadienyl)(2,7-diethyl-9-fluorenyl)zirconium dichloride, diphenylmethylene(2,3,4-trimethyl-1-cyclopentadienyl)(2,7-diethyl-9-fluorenyl)zirconium dichloride, diphenylmethylene(2,3,5-trimethyl-1-cyclopentadienyl)(2,7-diethyl-9-fluorenyl)zirconium dichloride, diphenylmethylene(3,4,5-trimethyl-1-cyclopentadienyl)(2,7-diethyl-9-fluorenyl)zirconium dichloride, diphenylmethylene(2,3,4,5-tetramethyl-1-cyclopentadienyl)(2,7-diethyl-9-fluorenyl)zirconium dichloride, diphenylmethylene(2-ethyl-1-cyclopentadienyl)(2,7-diethyl-9-fluorenyl)zirconium dichloride, diphenylmethylene(3-ethyl-1-cyclopentadienyl)(2,7-diethyl-9-fluorenyl)zirconium dichloride, diphenylmethylene(2,4-diethyl-1-cyclopentadienyl)(2,7-diethyl-9-fluorenyl)zirconium dichloride, diphenylmethylene(2,5-diethyl-1-cyclopentadienyl)(2,7-diethyl-9-fluorenyl)zirconium dichloride, diphenylmethylene(3,4-diethyl-1-cyclopentadienyl)(2,7-diethyl-9-fluorenyl)zirconium dichloride, diphenylmethylene(2,3,4-triethyl-1-cyclopentadienyl)(2,7-diethyl-9-fluorenyl)zirconium dichloride, diphenylmethylene(2,3,5-triethyl-1-cyclopentadienyl)(2,7-diethyl-9-fluorenyl)zirconium dichloride, diphenylmethylene(3,4,5-triethyl-1-cyclopentadienyl)(2,7-diethyl-9-fluorenyl)zirconium dichloride, diphenylmethylene(2,3,4,5-tetraethyl-1-cyclopentadienyl)(2,7-diethyl-9-fluorenyl)zirconium dichloride, diphenylmethylene(2-n-propyl-1-cyclopentadienyl)(2,7-diethyl-9-fluorenyl)zirconium dichloride, diphenylmethylene(3-n-propyl-1-cyclopentadienyl)(2,7-diethyl-9-fluorenyl)zirconium dichloride, diphenylmethylene(2,4-di-n-propyl-1-cyclopentadienyl)(2,7-diethyl-9-fluorenyl)zirconium dichloride, diphenylmethylene(2,5-di-n-propyl-1-cyclopentadienyl)(2,7-diethyl-9-fluorenyl)zirconium dichloride, diphenylmethylene(3,4-di-n-propyl-1-cyclopentadienyl)(2,7-diethyl-9-fluorenyl)zirconium dichloride, diphenylmethylene(2,3,4-tri-n-propyl-1-cyclopentadienyl)(2,7-diethyl-9-fluorenyl)zirconium dichloride, diphenylmethylene(2,3,5-tri-n-propyl-1-cyclopentadienyl)(2,7-diethyl-9-fluorenyl)zirconium dichloride, diphenylmethylene(3,4,5-tri-n-propyl-1-cyclopentadienyl)(2,7-diethyl-9-fluorenyl)zirconium dichloride, diphenylmethylene(2,3,4,5-tetra-n-propyl-1-cyclopentadienyl)(2,7-diethyl-9-fluorenyl)zirconium dichloride, diphenylmethylene(2-isoropyl-1-cyclopentadienyl)(2,7-diethyl-9-fluorenyl)zirconium dichloride, diphenylmethylene(3-isoropyl-1-cyclopentadienyl)(2,7-diethyl-9-fluorenyl)zirconium dichloride, diphenylmethylene(2,4-diisopropyl-1-cyclopentadienyl)(2,7-diethyl-9-fluorenyl)zirconium dichloride, diphenylmethylene(2,5-diisopropyl-1-cyclopentadienyl)(2,7-diethyl-9-fluorenyl)zirconium dichloride, diphenylmethylene(3,4-diisopropyl-1-cyclopentadienyl)(2,7-diethyl-9-fluorenyl)zirconium dichloride, diphenylmethylene(2,3,4-triisopropyl-1-cyclopentadienyl)(2,7-diethyl-9-fluorenyl)zirconium dichloride, diphenylmethylene(2,3,5-triisopropyl-1-cyclopentadienyl)(2,7-diethyl-9-fluorenyl)zirconium dichloride, diphenylmethylene(3,4,5-triisopropyl-1-cyclopentadienyl)(2,7-diethyl-9-fluorenyl)zirconium dichloride, diphenylmethylene(2,3,4,5-tetraisopropyl-1-cyclopentadienyl)(2,7-diethyl-9-fluorenyl)zirconium dichloride, diphenylmethylene(2-phenyl-1-cyclopentadienyl)(2,7-diethyl-9-fluorenyl)zirconium dichloride, diphenylmethylene(3-phenyl-1-cyclopentadienyl)(2,7-diethyl-9-fluorenyl)zirconium dichloride, diphenylmethylene(2,4-dipheyl-1-cyclopentadienyl)(2,7-diethyl-9-fluorenyl)zirconium dichloride, diphenylmethylene(2,5-diphenyl-1-cyclopentadienyl)(2,7-diethyl-9-fluorenyl)zirconium dichloride, diphenylmethylene(3,4-diphenyl-1-cyclopentadienyl)(2,7-diethyl-9-fluorenyl)zirconium dichloride, diphenylmethylene(2,3,4-triphenyl-1-cyclopentadienyl)(2,7-diethyl-9-fluorenyl)zirconium dichloride, diphenylmethylene(2,3,5-triphenyl-1-cyclopentadienyl)(2,7-diethyl-9-fluorenyl)zirconium dichloride, diphenylmethylene(3,4,5-triphenyl-1-cyclopentadienyl)(2,7-diethyl-9-fluorenyl)zirconium dichloride, diphenylmethylene(2,3,4,5-tetraphenyl-1-cyclopentadienyl)(2,7-diethyl-9-fluorenyl)zirconium dichloride, diphenylmethylene(2-trimethylsilyl-1-cyclopentadienyl)(2,7-diethyl-9-fluorenyl)zirconium dichloride, diphenylmethylene(3-trimethylsilyl-1-cyclopentadienyl)(2,7-diethyl-9-fluorenyl)zirconium dichloride, diphenylmethylene(2,4-bis(trimethylsilyl)-1-cyclopentadienyl)(2,7-diethyl-9-fluorenyl)zirconium dichloride, diphenylmethylene(2,5-bis(trimethylsilyl)-1-cyclopentadienyl)(2,7-diethyl-9-fluorenyl)zirconium dichloride, diphenylmethylene(3,4-bis(trimethylsilyl)-1-cyclopentadienyl)(2,7-diethyl-9-fluorenyl)zirconium dichloride, diphenylmethylene(2,3,4-tris(trimethylsilyl)-1-cyclopentadienyl)(2,7-diethyl-9-fluorenyl)zirconium dichloride, diphenylmethylene(2,3,5-tris(trimethylsilyl)-1-cyclopentadienyl)(2,7-diethyl-9-fluorenyl)zirconium dichloride, diphenylmethylene(3,4,5-tris(trimethylsilyl)-1-cyclopentadienyl)(2,7-diethyl-9-fluorenyl)zirconium dichloride, diphenylmethylene(2,3,4,5-tetrakis(trimethylsilyl)-1-cyclopentadienyl)(2,7-diethyl-9-fluorenyl)zirconium dichloride, diphenylmethylene(1-cyclopentadienyl)(2,7-di-tert-butyl-9-fluorenyl)zirconium dichloride, diphenylmethylene(2-methyl-1-cyclopentadienyl)(2,7-di-tert-butyl-9-fluorenyl)zirconium dichloride, diphenylmethylene(3-methyl-1-cyclopentadienyl)(2,7-di-tert-butyl-9-fluorenyl)zirconium dichloride, diphenylmethylene(2,4-dimethyl-1-cyclopentadienyl)(2,7-di-tert-butyl-9-fluorenyl)zirconium dichloride, diphenylmethylene(2,5-dimethyl-1-cyclopentadienyl)(2,7-di-tert-butyl-9-fluorenyl)zirconium dichloride, diphenylmethylene(3,4-dimethyl-1-cyclopentadienyl)(2,7-di-tert-butyl-9-fluorenyl)zirconium dichloride, diphenylmethylene(2,3,4-trimethyl-1-cyclopentadienyl)(2,7-di-tert-butyl-9-fluorenyl)zirconium dichloride, diphenylmethylene(2,3,5-trimethyl-1-cyclopentadienyl)(2,7-di-tert-butyl-9-fluorenyl)zirconium dichloride, diphenylmethylene(3,4,5-trimethyl-1-cyclopentadienyl)(2,7-di-tert-butyl-9-fluorenyl)zirconium dichloride, diphenylmethylene(2,3,4,5-tetramethyl-1-cyclopentadienyl)(2,7-di-tert-butyl-9-fluorenyl)zirconium dichloride, diphenylmethylene(2-ethyl-1-cyclopentadienyl)(2,7-di-tert-butyl-9-fluorenyl)zirconium dichloride, diphenylmethylene(3-ethyl-1-cyclopentadienyl)(2,7-di-tert-butyl-9-fluorenyl)zirconium dichloride, diphenylmethylene(2,4-diethyl-1-cyclopentadienyl)(2,7-di-tert-butyl-9-fluorenyl)zirconium dichloride, diphenylmethylene(2,5-diethyl-1-cyclopentadienyl)(2,7-di-tert-butyl-9-fluorenyl)zirconium dichloride, diphenylmethylene(3,4-diethyl-1-cyclopentadienyl)(2,7-di-tert-butyl-9-fluorenyl)zirconium dichloride, diphenylmethylene(2,3,4-triethyl-1-cyclopentadienyl)(2,7-di-tert-butyl-9-fluorenyl)zirconium dichloride, diphenylmethylene(2,3,5-triethyl-1-cyclopentadienyl)(2,7-di-tert-butyl-9-fluorenyl)zirconium dichloride, diphenylmethylene(3,4,5-triethyl-1-cyclopentadienyl)(2,7-di-tert-butyl-9-fluorenyl)zirconium dichloride, diphenylmethylene(2,3,4,5-tetraethyl-1-cyclopentadienyl)(2,7-di-tert-butyl-9-fluorenyl)zirconium dichloride, diphenylmethylene(2-n-propyl-1-cyclopentadienyl)(2,7-di-tert-butyl-9-fluorenyl)zirconium dichloride, diphenylmethylene(3-n-propyl-1-cyclopentadienyl)(2,7-di-tert-butyl-9-fluorenyl)zirconium dichloride, diphenylmethylene(2,4-di-n-propyl-1-cyclopentadienyl)(2,7-di-tert-butyl-9-fluorenyl)zirconium dichloride, diphenylmethylene(2,5-di-n-propyl-1-cyclopentadienyl)(2,7-di-tert-butyl-9-fluorenyl)zirconium dichloride, diphenylmethylene(3,4-di-n-propyl-1-cyclopentadienyl)(2,7-di-tert-butyl-9-fluorenyl)zirconium dichloride, diphenylmethylene(2,3,4-tri-n-propyl-1-cyclopentadienyl)(2,7-di-tert-butyl-9-fluorenyl)zirconium dichloride, diphenylmethylene(2,3,5-tri-n-propyl-1-cyclopentadienyl)(2,7-di-tert-butyl-9-fluorenyl)zirconium dichloride, diphenylmethylene(3,4,5-tri-n-propyl-1-cyclopentadienyl)(2,7-di-tert-butyl-9-fluorenyl)zirconium dichloride, diphenylmethylene(2,3,4,5-tetra-n-propyl-1-cyclopentadienyl)(2,7-di-tert-butyl-9-fluorenyl)zirconium dichloride, diphenylmethylene(2-isoropyl-1-cyclopentadienyl)(2,7-di-tert-butyl-9-fluorenyl)zirconium dichloride, diphenylmethylene(3-isoropyl-1-cyclopentadienyl)(2,7-di-tert-butyl-9-fluorenyl)zirconium dichloride, diphenylmethylene(2,4-diisopropyl-1-cyclopentadienyl)(2,7-di-tert-butyl-9-fluorenyl)zirconium dichloride, diphenylmethylene(2,5-diisopropyl-1-cyclopentadienyl)(2,7-di-tert-butyl-9-fluorenyl)zirconium dichloride, diphenylmethylene(3,4-diisopropyl-1-cyclopentadienyl)(2,7-di-tert-butyl-9-fluorenyl)zirconium dichloride, diphenylmethylene(2,3,4-triisopropyl-1-cyclopentadienyl)(2,7-di-tert-butyl-9-fluorenyl)zirconium dichloride, diphenylmethylene(2,3,5-triisopropyl-1-cyclopentadienyl)(2,7-di-tert-butyl-9-fluorenyl)zirconium dichloride, diphenylmethylene(3,4,5-triisopropyl-1-cyclopentadienyl)(2,7-di-tert-butyl-9-fluorenyl)zirconium dichloride, diphenylmethylene(2,3,4,5-tetraisopropyl-1-cyclopentadienyl)(2,7-di-tert-butyl-9-fluorenyl)zirconium dichloride, diphenylmethylene(2-phenyl-1-cyclopentadienyl)(2,7-di-tert-butyl-9-fluorenyl)zirconium dichloride, diphenylmethylene(3-phenyl-1-cyclopentadienyl)(2,7-di-tert-butyl-9-fluorenyl)zirconium dichloride, diphenylmethylene(2,4-dipheyl-1-cyclopentadienyl)(2,7-di-tert-butyl-9-fluorenyl)zirconium dichloride, diphenylmethylene(2,5-diphenyl-1-cyclopentadienyl)(2,7-di-tert-butyl-9-fluorenyl)zirconium dichloride, diphenylmethylene(3,4-diphenyl-1-cyclopentadienyl)(2,7-di-tert-butyl-9-fluorenyl)zirconium dichloride, diphenylmethylene(2,3,4-triphenyl-1-cyclopentadienyl)(2,7-di-tert-butyl-9-fluorenyl)zirconium dichloride, diphenylmethylene(2,3,5-triphenyl-1-cyclopentadienyl)(2,7-di-tert-butyl-9-fluorenyl)zirconium dichloride, diphenylmethylene(3,4,5-triphenyl-1-cyclopentadienyl)(2,7-di-tert-butyl-9-fluorenyl)zirconium dichloride, diphenylmethylene(2,3,4,5-tetraphenyl-1-cyclopentadienyl)(2,7-di-tert-butyl-9-fluorenyl)zirconium dichloride, diphenylmethylene(2-trimethylsilyl-1-cyclopentadienyl)(2,7-di-tert-butyl-9-fluorenyl)zirconium dichloride, diphenylmethylene(3-trimethylsilyl-1-cyclopentadienyl)(2,7-di-tert-butyl-9-fluorenyl)zirconium dichloride, diphenylmethylene(2,4-bis(trimethylsilyl)-1-cyclopentadienyl)(2,7-di-tert-butyl-9-fluorenyl)zirconium dichloride, diphenylmethylene(2,5-bis(trimethylsilyl)-1-cyclopentadienyl)(2,7-di-tert-butyl-9-fluorenyl)zirconium dichloride, diphenylmethylene(3,4-bis(trimethylsilyl)-1-cyclopentadienyl)(2,7-di-tert-butyl-9-fluorenyl)zirconium dichloride, diphenylmethylene(2,3,4-tris(trimethylsilyl)-1-cyclopentadienyl)(2,7-di-tert-butyl-9-fluorenyl)zirconium dichloride, diphenylmethylene(2,3,5-tris(trimethylsilyl)-1-cyclopentadienyl)(2,7-di-tert-butyl-9-fluorenyl)zirconium dichloride, diphenylmethylene(3,4,5-tris(trimethylsilyl)-1-cyclopentadienyl)(2,7-di-tert-butyl-9-fluorenyl)zirconium dichloride, and diphenylmethylene(2,3,4,5-tetrakis(trimethylsilyl)-1-cyclopentadienyl)(2,7-di-tert-butyl-9-fluorenyl)zirconium dichloride.

Also, examples of the transition metal compound (component (A2)) represented by the general formula (3) are compounds obtained by changing “dichloride” (two X²s) in the above-exemplified transition metal compounds to “difluoride”, “dibromide”, “diiodide”, “dimethyl”, “diethyl”, “diisopropyl”, “dimethoxide”, “diethoxide”, “dipropoxide”, “dibutoxide”, “bis(trifluoromethoxide)”, “diphenyl”, “diphenoxide”, “bis(2,6-di-tert-butylphenoxide)”, “bis(3,4,5-trifluorophenoxide)”, “bis(pentafluorophenoxide)”, “bis(2,3,5,6-tetrafluoro-4-pentafluorophenylphenoxide)”, or “dibenzyl”. Further examples thereof are compounds obtained by changing “diphenylmethylene” (Q²) in the above-exemplified transition metal compounds to “methylene”, “ethylene”, “isopropylidene”, “methylphenylmethylene”, “dimethylsilanediyl”, “diphenylsilanediyl”, “silacyclobutanediyl” or “silacyclohexanediyl”. Still further examples thereof are compounds obtained by changing “zirconium” (M²) in the above-exemplified transition metal compounds to “titanium” or “hafnium”.

The transition metal compound (component (A2)) represented by the general formula (3) is preferably diphenylmethylene(1-cyclopentadienyl)(9-fluorenyl)zirconium dichloride.

M³ in the general formula (5) is a lithium atom, a sodium atom, a potassium atom, a rubidium atom, a cesium atom, a beryllium atom, a magnesium atom, a calcium atom, a strontium atom, a barium atom, a zinc atom, a germanium atom, a tin atom, a lead atom, a antimony atom or a bismuth atom. Among them, preferred is a magnesium atom, a calcium atom, a strontium atom, a barium atom, a zinc atom, a germanium atom, a tin atom or a bismuth atom, more preferred is a magnesium atom, a zinc atom, a tin atom or a bismuth atom, and further preferred is a zinc atom.

X in the general formula (5) is a number corresponding to the valence of M³. When M³ is a zinc atom, for example, X is 2.

L in the general formula (5) is a hydrogen atom, a halogen atom or a hydrocarbyl group optionally having one or more substituents, and when plural Ls exist, they are the same as, or different from one another.

Examples of the halogen atom of L are a fluorine atom, a chlorine atom, a bromine atom and an iodine atom. Examples of the hydrocarbyl group optionally having one or more substituents of L are an alkyl group, an aralkyl group, an aryl group, and a halogenated alkyl group.

The alkyl group of L is preferably alkyl groups having 1 to 20 carbon atoms. Examples thereof are a methyl group, an ethyl group, a n-propyl group, an isopropyl group, a n-butyl group, an isobutyl group, a sec-butyl group, a tert-butyl group, a n-pentyl group, a neopentyl group, an isopentyl group, a n-hexyl group, a n-heptyl group, a n-octyl group, a n-decyl group, a n-nonyl group, a n-decyl group, a n-dodecyl group, a n-dodecyl group, a n-tridecyl group, a n-tetradecyl group, a n-pentadecyl group, a n-hexadecyl group, a n-heptadecyl group, a n-octadecyl group, a n-nonadecyl group, and a n-eicosyl group. Among them, preferred is a methyl group, an ethyl group, an isopropyl group, a tert-butyl group or an isobutyl group.

The halogenated alkyl group of L is preferably halogenated alkyl groups having 1 to 20 carbon atoms. Examples thereof are a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group; a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchioropropyl group, a perchiorobutyl group, a perchioropentyl group, a perchiorohexyl group, a perchlorooctyl group, a perchiorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group, and a perbromoeicosyl group.

The aralkyl group of L is preferably aralkyl groups having 7 to 20 carbon atoms. Examples thereof are a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (4,6-dimethylphenyl)methyl group, a (2,3,4-trimethylphenyl)methyl group, a (2,3,5-trimethylphenyl)methyl group, a (2,3,6-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, a (n-propylphenyl)methyl group, an (isopropylphenyl)methyl group, a (n-butylphenyl)methyl group, a (sec-butylphenyl)methyl group, a (tert-butylphenyl)methyl group, a (n-pentylphenyl)methyl group, a (neopentylphenyl)methyl group, a (n-hexylphenyl)methyl group, a (n-octylphenyl)methyl group, a (n-decylphenyl)methyl group, a (n-decylphenyl)methyl group, a (n-tetradecylphenyl)methyl group, a naphthylmethyl group, an anthracenylmethyl group, a phenylethyl group, a phenylpropyl group, a phenylbutyl group, a diphenylmethyl group, a diphenylethyl group, a diphenylpropyl group, and a diphenylbutyl group. Among them, preferred is a benzyl group. Also, examples thereof are halogenated aralkyl groups having 7 to 20 carbon atoms obtained by substituting the above-exemplified aralky groups with a halogen atom such as a fluorine atom, a chlorine atom, a bromine atom and an iodine atom.

The aryl group of L is preferably aryl groups having 6 to 20 carbon atoms. Examples thereof are a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a diethylpheny group, a triethylpheny group, a n-propylphenyl group, an isopropylphenyl group, a n-butylphenyl group, a sec-butylphenyl group, a tert-butylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group and an anthracenyl group. Among them, preferred is a phenyl group. Also, examples thereof are halogenated aryl groups having 6 to 20 carbon atoms obtained by substituting the above-exemplified aryl groups with a halogen atom such as a fluorine atom, a chlorine atom, a bromine atom and an iodine atom.

L is preferably a hydrogen atom, alkyl groups or aryl groups, more preferably a hydrogen atom or alkyl groups, and further preferably alkyl groups.

T¹ in the general formula (6) is an oxygen atom, a sulfur atom, a nitrogen atom or a phosphorus atom. Among them, preferred is a nitrogen atom or an oxygen atom, and more preferred is an oxygen atom.

t in the general formula (6) is a number corresponding to the valence of T¹. When T¹ is an oxygen atom or a sulfur atom, t is 2, and when T¹ is a nitrogen atom or a phosphorus atom, t is 3.

R⁶ in the general formula (6) is a halogen atom, an electron-withdrawing group, a halogen atom-containing group, or a group containing an electron-withdrawing group, and when plural R⁶s exist, they are the same as, or different from one another. As an index of an electron-withdrawing property, there is known, for example, a substituent constant, a, in the Hammet's rule, and functional groups having a positive a are examples of the electron-withdrawing group.

Examples of the halogen atom of R⁶ are a fluorine atom, a chlorine atom, a bromine atom and an iodine atom.

Examples of the electron-withdrawing group of R⁶ are a cyano group, a nitro group, a carbonyl group, a hydrocarbyloxycarbonyl group, a sulfone group and a phenyl group.

Examples of the halogen atom-containing group of R⁶ are halogenated hydrocarbyl groups such as halogenated alkyl groups, halogenated aralkyl groups, halogenated aryl groups, (halogenated alkyl)aryl groups; halogenated hydrocarbyloxy groups; and halogenated hydrocarbyloxycarbonyl groups. Examples of the group containing an electron-withdrawing group of R⁶ are cyanated hydrocarbyl groups such as cyanated aryl groups; and nitrated hydrocarbyl groups such as nitrated aryl groups.

Examples of the halogenated alkyl groups of R⁶ are a fluoromethyl group, a chloromethyl group, a bromomethyl group, an iodomethyl group, a difluoromethyl group, a dichioromethyl group, a dibromomethyl group, a diiodomethyl group, a trifluoromethyl group, a trichloromethyl group, a tribromomethyl group, a triiodomethyl group, a 2,2,2-trifluoroethyl group, a 2,2,2-trichloroethyl group, a 2,2,2-tribromoethyl group, a 2,2,2-triiodoethyl group, a 2,2,3,3,3-pentafluoropropyl group, a 2,2,3,3,3-pentachloropropyl group, a 2,2,3,3,3-pentabromopropyl group, a 2,2,3,3,3-pentaiodopropyl group, a 2,2,2-trifluoro-1-trifluoromethylethyl group, a 2,2,2-trichloro-1-trichloromethylethyl group, a 2,2,2-tribromo-1-tribromomethylethyl group, a 2,2,2-triiodo-1-triiodomethylethyl group, a 1,1-bis(trifluoromethyl)-2,2,2-trifluoroethyl group, a 1,1-bis(trichloromethyl)-2,2,2-trichloroethyl group, a 1,1-bis(tribromomethyl)-2,2,2-tribromoethyl group, and a 1,1-bis(triiodomethyl)-2,2,2-triiodoethyl group.

Examples of the halogenated aryl groups of R⁶ are 2-fluorophenyl group, a 3-fluorophenyl group, a 4-fluorophenyl group, a 2,4-difluorophenyl group, a 2,6-difluorophenyl group, a 3,4-difluorophenyl group, a 3,5-difluorophenyl group, a 2,4,6-trifluorophenyl group, a 3,4,5-trifluorophenyl group, a 2,3,5,6-tetrafluorophenyl group, a pentafluorophenyl group, a 2,3,5,6-tetrafluoro-4-trifluoromethylphenyl group, a 2,3,5,6-tetrafluoro-4-pentafluorophenylphenyl group, a perfluoro-1-naphthyl group, a perfluoro-2-naphthyl group, 2-chlorophenyl group, a 3-chlorophenyl group, a 4-chlorophenyl group, a 2,4-dichlorophenyl group, a 2,6-dichlorophenyl group, a 3,4-dichlorophenyl group, a 3,5-dichlorophenyl group, a 2,4,6-trichlorophenyl group, a 3,4,5-trichlorophenyl group, a 2,3,5,6-tetrachlorophenyl group, a pentachlorophenyl group, a 2,3,5,6-tetrachloro-4-trichloromethylphenyl group, a 2,3,5,6-tetrachloro-4-pentachlorophenylphenyl group, a perchloro-1-naphthyl group, a perchloro-2-naphthyl group, 2-bromophenyl group, a 3-bromophenyl group, a 4-bromophenyl group, a 2,4-dibromophenyl group, a 2,6-dibromophenyl group, a 3,4-dibromophenyl group, a 3,5-dibromophenyl group, a 2,4,6-tribromophenyl group, a 3,4,5-tribromophenyl group, a 2,3,5,6-tetrabromophenyl group, a pentabromophenyl group, a 2,3,5,6-tetrabromo-4-tribromomethylphenyl group, a 2,3,5,6-tetrabromo-4-pentabromophenylphenyl group, a perbromo-1-naphthyl group, a perbromo-2-naphthyl group, 2-iodophenyl group, a 3-iodophenyl group, a 4-iodophenyl group, a 2,4-diiodophenyl group, a 2,6-diiodophenyl group, a 3,4-diiodophenyl group, a 3,5-diiodophenyl group, a 2,4,6-triiodophenyl group, a 3,4,5-triiodophenyl group, a 2,3,5,6-tetraiodophenyl group, a pentaiodophenyl group, a 2,3,5,6-tetraiodo-4-triiodomethylphenyl group, a 2,3,5,6-tetraiodo-4-pentaiodophenylphenyl group, a periodo-1-naphthyl group, and a periodo-2-naphthyl group. Examples of the (halogenated alkyl)aryl groups of R⁶ are a 2-(trifluoromethyl)phenyl group, a 3-(trifluoromethyl)phenyl group, a 4-(trifluoromethyl)phenyl group, a 2,6-bis(trifluoromethyl)phenyl group, a 3,5-bis(trifluoromethyl)phenyl group, a 2,4,6-tris(trifluoromethyl)phenyl group, and a 3,4,5-tris(trifluoromethyl)phenyl group.

Examples of the cyanated aryl groups of R⁶ are a 2-cyanophenyl group, a 3-cyanophenyl group and a 4-cyanophenyl group.

Examples of the nitrated aryl groups of R⁶ are a 2-nitrophenyl group, a 3-nitrophenyl group and a 4-nitrophenyl group.

Examples of the hydrocarbyloxycarbonyl groups of R⁶ are alkoxycarbonyl groups, aralkyloxycarbonyl groups, and aryloxycarbonyl groups. More specific examples thereof are a methoxycarbonyl group, an ethoxycarbonyl group, a n-propoxycarbonyl group, an isopropoxycarbonyl group, and a phenoxycarbonyl group.

Examples of the halogenated hydrocarbyloxycarbonyl groups of R⁶ are halogenated alkoxycarbonyl groups, halogenated aralkyloxycarbonyl groups, and halogenated aryloxycarbonyl groups. More specific examples thereof are a trifluoromethoxycarbonyl group and a pent afluorophenoxycarbonyl group.

R⁶ is preferably halogenated hydrocarbyl groups, more preferably halogenated alkyl groups or halogenated aryl groups, further preferably fluorinated alkyl groups, fluorinated aryl groups, chlorinated alkyl groups or chlorinated aryl groups, and particularly preferably fluorinated alkyl groups or fluorinated aryl groups. The fluorinated alkyl groups are preferably a fluoromethyl group, a difluoromethyl group, a trifluoromethyl group, a 2,2,2-trifluoroethyl group, a 2,2,3,3,3-pentafluoropropyl group, a 2,2,2-trifluoro-1-trifluoromethylethyl group, or a 1,1-bis(trifluoromethyl)-2,2,2-trifluoroethyl group, and more preferably a trifluoromethyl group, a 2,2,2-trifluoro-1-trifluoromethylethyl group, or a 1,1-bis(trifluoromethyl)-2,2,2-trifluoroethyl group. The fluorinated aryl groups are preferably a 2-fluorophenyl group, a 3-fluorophenyl group, a 4-fluorophenyl group, a 2,4-difluorophenyl group, a 2,6-difluorophenyl group, a 3,4-difluorophenyl group, a 3,5-difluorophenyl group, a 2,4,6-trifluorophenyl group, a 3,4,5-trifluorophenyl group, a 2,3,5,6-tetrafluorophenyl group, a pentafluorophenyl group, a 2,3,5,6-tetrafluoro-4-trifluoromethylphenyl group, a 2,3,5,6-tetrafluoro-4-pentafluorophenylphenyl group, a perfluoro-1-naphtyl group, or a perfluoro-2-naphtyl group, and more preferably a 3,5-difluorophenyl group, a 3,4,5-trifluorophenyl group, or a pentafluorophenyl group. The chlorinated alkyl groups are preferably a chloromethyl group, a dichloromethyl group, a trichloromethyl group, a 2,2,2-trichloroethyl group, a 2,2,3,3,3-pentachloropropyl group, a 2,2,2-trichloro-1-trichloromethylethyl group, or a 1,1-bis(trichloromethyl)-2,2,2-trichloroethyl group. The chlorinated aryl groups are preferably a 4-chlorophenyl group, a 2,6-dichlorophenyl group, a 3,5-dichlorophenyl group, a 2,4,6-trichlorophenyl group, a 3,4,5-trichiorophenyl group or a pentachlorophenyl group.

T² in the general formula (7) is an oxygen atom, a sulfur atom, a nitrogen atom or a phosphorus atom. Among them, preferred is a nitrogen atom or an oxygen atom, and more preferred is an oxygen atom.

s in the general formula (7) is a number corresponding to the valence of T². When T² is an oxygen atom or a sulfur atom, s is 2, and when T² is a nitrogen atom or a phosphorus atom, s is 3.

R⁷ in the general formula (7) is a hydrocarbyl group or a halogenated hydrocarbyl group. Examples of the hydrocarbyl group of R⁷ are alkyl groups, aralkyl groups and aryl groups. Specific examples thereof are those exemplified as the alkyl groups, the aralkyl groups and the aryl groups of L, respectively. Examples of the halogenated hydrocarbyl group of R⁷ are halogenated alkyl groups, halogenated aralkyl groups, halogenated aryl groups, and (halogenated alkyl)aryl group. Specific examples thereof are those exemplified as the halogenated alkyl groups, the halogenated aryl groups, and the (halogenated alkyl)aryl groups of R⁶, respectively.

R⁷ is preferably halogenated hydrocarbyl groups, and more preferably fluorinated hydrocarbyl groups.

Examples of the compound (component (b1)) represented by the general formula (5), in case that M³ is a zinc atom, are dialkyl zincs such as dimethyl zinc, diethyl zinc, di-n-propyl zinc, diisopropyl zinc, di-n-butyl zinc, diisobutyl zinc, and di-n-hexyl zinc; diaryl zincs such as diphenyl zinc, dinaphthyl zinc and bis(pentafluorophenyl)zinc; dialkenyl zincs such as diallyl zinc; bis(cyclopentadienyl)zinc; halogenated alkyl zincs such as chloromethyl zinc, chloroethyl zinc, chloro-n-propyl zinc, chloroisopropyl zinc, chloro-n-butyl zinc, chloroisobutyl zinc, chloro-n-hexyl zinc, bromomethyl zinc, bromoethyl zinc, bromo-n-propyl zinc, bromoisopropyl zinc, bromo-n-butyl zinc, bromoisobutyl zinc, bromo-n-hexyl zinc, iodomethyl zinc, iodoethyl zinc, iodo-n-propyl zinc, iodoisopropyl zinc, iodo-n-butyl zinc, iodoisobutyl zinc, and iodo-n-hexyl zinc; and zinc halides such as zinc fluoride, zinc chloride, zinc bromide, and zinc iodide.

The compound (component (b1)) represented by the general formula (5) is preferably dialkyl zincs, further preferably dimethyl zinc, diethyl zinc, di-n-propyl zinc, diisopropyl zinc, di-n-butyl zinc, diisobutyl zinc, or di-n-hexyl zinc, and particularly preferably dimethyl zinc or diethyl zinc.

Examples of the compound (component (b2)) represented by the general formula (6) are amines, phosphines, alcohols, thiols, phenols, thiophenols, naphthols, naphthylthiols, and carboxylic acids.

Examples of the amines are di(fluoromethyl)amine, bis(difluoromethyl)amine, bis(trifluoromethyl)amine, bis(2,2,2-trifluoroethyl)amine, bis(2,2,3,3,3-pentafluoropropyl)amine, bis(2,2,2-trifluoro-1-trifluoromethylethyl)amine, bis(1,1-bis(trifluoromethyl)-2,2,2-trifluoroethyl)amine, bis(2-fluorophenyl)amine, bis(3-fluorophenyl)amine, bis(4-fluorophenyl)amine, bis(2,6-difluorophenyl)amine, bis(3,5-difluorophenyl)amine, bis(2,4,6-trifluorophenyl)amine, bis(3,4,5-trifluorophenyl)amine, bis(pentafluorophenyl)amine, bis(2-(trifluoromethyl)phenyl)amine, bis(3-(trifluoromethyl)phenyl)amine, bis(4-(trifluoromethyl)phenyl)amine, bis(2,6-di(trifluoromethyl)phenyl)amine, bis(3,5-di(trifluoromethyl)phenyl)amine, bis(2,4,6-tri(trifluoromethyl)phenyl)amine, bis(2-cyanophenyl)amine, (3-cyanophenyl)amine, bis(4-cyanophenyl)amine, bis(2-nitrophenyl)amine, bis(3-nitrophenyl)amine, bis(4-nitrophenyl)amine, bis(1H,1H-perfluorobutyl)amine, bis(1H,1H-perfluoropentyl)amine, bis(1H,1H-perfluorohexyl)amine, bis(1H,1H-perfluorooctyl)amine, bis(1H,1H-perfluorododecyl)amine, bis(1H,1H-perfluoropentadecyl)amine, and bis(1H,1H-perfluoroeicosyl)amine. Also, examples thereof are amines obtained by changing “fluoro” in the above-exemplified amines to “chloro”, “bromo” or “iodo”.

Examples of the phosphines are compounds obtained by changing a nitrogen atom in the above-exemplified amines to a phosphorous atom. Those phosphines are named by replacing “amine” in the above-exemplified amines with “phosphine”.

Examples of the alcohols are fluoromethanol, difluoromethanol, trifluoromethanol, 2,2,2-trifluoroethanol, 2,2,2,3,3,3-pentafluoropropanol, 2,2,2-trifluoro-1-trifluoromethylethanol, 1,1-bis(trifluoromethyl)-2,2,2-trifluoroethanol, 1H,1H-perfluorobutanol, 1H,1H-perfluoropentanol, 1H,1H-perfluorohexanol, 1H,1H-perfluorooctanol, 1H,1H-perfluorododecanol, 1H,1H-perfluoropentadecanol, and 1H,1H-perfluoroeicosanol. Also, examples thereof are alcohols obtained by changing “fluoro” in the above-exemplified alcohols to “chloro”, “bromo” or “iodo”.

Examples of the thiols are compounds obtained by changing an oxygen atom in the above-exemplified alcohols to a sulfur atom. Those thiols are named by replacing “nol” in the above-exemplified alcohols with “nthiol”.

Examples of the phenols are 2-fluorophenol, 3-fluorophenol, 4-fluorophenol, 2,4-difluorophenol, 2,6-difluorophenol, 3,4-difluorophenol, 3,5-difluorophenol, 2,4,6-trifluorophenol, 3,4,5-trifluorophenol, 2,3,5,6-tetrafluorophenol, pentafluorophenol, 2,3,5,6-tetrafluoro-4-trifluoromethylphenol, and 2,3,5,6-tetrafluoro-4-pentafluorophenylphenol. Also, examples thereof are phenols obtained by changing “fluoro” in the above-exemplified phenols to “chloro”, “bromo” or “iodo”.

Examples of the thiophenols are compounds obtained by changing an oxygen atom in the above-exemplified phenols to a sulfur atom. Those thiophenols are named by replacing “phenol” in the above-exemplified phenols with “thiophenol”.

Examples of the naphthols are perfluoro-1-naphthol, perfluoro-2-naphthol, 4,5,6,7,8-pentafluoro-2-naphthol, 2-(trifluoromethyl)phenol, 3-(trifluoromethyl)phenol, 4-(trifluoromethyl)phenol, 2,6-bis(trifluoromethyl)phenol, 3,5-bis (trifluoromethyl) phenol, 2,4,6-tris(trifluoromethyl)phenol, 2-cyanophenol, 3-cyanophenol, 4-cyanophenol, 2-nitrophenol, 3-nitrophenol, and 4-nitrophenol. Also, examples thereof are naphthols obtained by changing “fluoro” in the above-exemplified naphthols to “chloro”, “bromo” or “iodo”.

Examples of the naphthylthiols are compounds obtained by changing an oxygen atom in the above-exemplified naphthols to a sulfur atom. Those naphthylthiols are named by replacing “naphthol” in the above-exemplified naphthols with “naphthylthiol”.

Examples of the carboxylic acids are pentafluorobenzoic acid, perfluoroethanoic acid, perfluoropropanoic acid, perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid and perfluorododecanoic acid.

The compound (component (b2)) represented by the general formula (6) is preferably amines, alcohols or phenols. The amines are preferably bis(trifluoromethyl)amine, bis (2,2,2-trifluoroethyl) amine, bis(2,2,3,3,3-pentafluoropropyl)amine, bis(2,2,2-trifluoro-1-trifluoromethylethyl)amine, bis(1,1-bis(trifluoromethyl)-2,2,2-trifluoroethyl)amine, or bis(pentafluorophenyl)amine. The alcohols are preferably trifluoromethanol, 2,2,2-trifluoroethanol, 2,2,3,3,3-pentafluoropropanol, 2,2,2-trifluoro-1-trifluoromethylethanol, or 1,1-bis(trifluoromethyl)-2,2,2-trifluoroetanol. The phenols are preferably 2-fluorophenol, 3-fluorophenol, 4-fluorophenol, 2,6-difluorophenol, 3,5-difluorophenol, 2,4,6-trifluorophenol, 3,4,5-trifluorophenol, pentafluorophenol, 2-(trifluoromethyl)phenol, 3-(trifluoromethyl)phenol, 4-(trifluoromethyl)phenol, 2,6-bis(trifluoromethyl)phenol, 3,5-bis(trifluoromethyl)phenol, 2,4,6-tris(trifluoromethyl)phenol, or 3,4,5-tris(trifluoromethyl)phenol.

The compound (component (b2)) represented by the general formula (6) is more preferably bis(trifluoromethyl)amine, bis(pentafluorophenyl)amine, trifluoromethanol, 2,2,2-trifluoro-1-trifluoromethylethanol, 1,1-bis(trifluoromethyl)-2,2,2-trifluoroetanol, 2-fluorophenol, 3-fluorophenol, 4-fluorophenol, 2,6-difluorophenol, 3,5-difluorophenol, 2,4,6-trifluorophenol, 3,4,5-trifluorophenol, pentafluorophenol, 4-(trifluoromethyl)phenol, 2,6-bis(trifluoromethyl)phenol, or 2,4,6-tris(trifluoromethyl)phenol, and further preferably 3,5-difluorophenol, 3,4,5-trifluorophenol, pentafluorophenol, or 1,1-bis(trifluoromethyl)-2,2,2-trifluoroetanol.

Examples of the compound (component (b3)) represented by the general formula (7) are water, hydrogen sulfide, amines and anilines.

Examples of the amines are alkylamines such as methyl amine, ethylamine, n-propylamine, isopropylamine, n-butylamine, sec-butylamine, tert-butylamine, isobutylamine, n-pentylamine, neopentylamine, isopentylamine, n-hexylamine, n-octylamine, n-decylamine, n-dodecylamine, n-pentadecylamine, and n-eicosylamine; aralkylamines such as benzylamine, (2-methylphenyl)methylamine, (3-methylphenyl)methylamine, (4-methylphenyl)methylamine, (2,3-dimethylphenyl)methylamine, (2,4-dimethylphenyl)methylamine, (2,5-dimethylphenyl)methylamine, (2,6-dimethylphenyl)methylamine, (3,4-dimethylphenyl)methylamine, (3,5-dimethylphenyl)methylamine, (2,3,4-trimethylphenyl)methylamine, (2,3,5-trimethylphenyl)methylamine, (2,3,6-trimethylphenyl)methylamine, (3,4,5-trimethylphenyl)methylamine, (2,4,6-trimethylphenyl)methylamine, (2,3,4,5-tetramethylphenyl)methylamine, (2,3,4,6-tetramethylphenyl)methylamine, (2,3,5,6-tetramethylphenyl)methylamine, (pentamethylphenyl)methylamine, (ethylphenyl)methylamine, (n-propylphenyl)methylamine, (isopropylphenyl)methylamine, (n-butylphenyl)methylamine, (sec-butylphenyl)methylamine, (tert-butylphenyl)methylamine, (n-pentylphenyl)methylamine, (neopentylphenyl)methylamine, (n-hexylphenyl)methylamine, (n-octylphenyl)methylamine, (n-decylphenyl)methylamine, (n-tetradecylphenyl)methylamine, naphthylmethylamine, and anthracenylmethylamine; allylamine; and cyclopentadienylamine.

Also, examples of the amines are halogenated alkylamines such as fluoromethylamine, difluoromethylamine, trifluoromethylamine, 2,2,2-trifluoroethylamine, 2,2,3,3,3-pentafluoropropylamine, 2,2,2-trifluoro-1-trifluoromethylethylamine, 1,1-bis(trifluoromethyl)-2,2,2-trifluoroethylamine, perfluoropropylamine, perfluorobutylamine, perfluoropentylamine, perfluorohexylamine, perfluorooctylamine, perfluorododecylamine, perfluoropentadecylamine, and perfluoroeicosylamine. Further, examples thereof are amines obtained by changing “fluoro” in the above-exemplified amines to “chloro”, “bromo” or “iodo”.

Examples of the anilines are aniline, naphthylamine, anthracenylamine, 2-methylaniline, 3-methylaniline, 4-methylaniline, 2,3-dimethylaniline, 2,4-dimethylaniline, 2,5-dimethylaniline, 2,6-dimethylaniline, 3,4-dimethylaniline, 3,5-dimethylaniline, 2,3,4-trimethylaniline, 2,3,5-trimethylaniline, 3,4,5-trimethylaniline, 2,3,4,5-tetramethylaniline, 2,3,4,6-tetramethylaniline, 2,3,5,6-tetramethylaniline, pentamethylaniline, 2-ethylaniline, 3-ethylaniline, 4-ethylaniline, 2,3-diethylaniline, 2,4-diethylaniline, 2,5-diethylaniline, 2,6-diethylaniline, 3,4-diethylaniline, 3,5-diethylaniline, 2,3,4-triethylaniline, 2,3,5-triethylaniline, 2,3,6-triethylaniline, 2,4,6-triethylaniline, 3,4,5-triethylaniline, 2,3,4,5-tetraethylaniline, 2,3,4,6-tetraethylaniline, 2,3,5,6-tetraethylaniline, and pentaethylaniline. Also, examples thereof are anilines obtained by changing “ethyl” in the above-exemplified anilines to “n-propyl”, “isopropyl”, “n-butyl”, “sec-butyl”, “tert-butyl”, “n-pentyl”, “neopentyl”, “n-hexyl”, “n-octyl”, “n-decyl”, “n-dodecyl” or “n-tetradecyl”.

Examples of the anilines are 2-fluoroaniline, 3-fluoroaniline, 4-fluoroaniline, 2,6-difluoroaniline, 3,5-difluoroaniline, 2,4,6-trifluoroaniline, 3,4,5-trifluoroaniline, pentafluoroaniline, 2-(trifluoromethyl)aniline, 3-(trifluoromethyl)aniline, 4-(trifluoromethyl)aniline, 2,6-di(trifluoromethyl)aniline, 3,5-di(trifluoromethyl)aniline and 2,4,6-tri(trifluoromethyl)aniline. Also, examples thereof are anilines obtained by changing “fluoro” in the above-exemplified anilines to “chloro”, “bromo” or “iodo”.

The compound (component (b3)) represented by the general formula (7) is preferably water, hydrogen sulfide, methyl amine, ethylamine, n-propylamine, isopropylamine, n-butylamine, sec-butylamine, tert-butylamine, isobutylamine, n-octylamine, aniline, 2,6-dimethylaniline, 2,4,6-trimethylaniline, naphthylamine, anthracenylamine, benzylamine, trifluoromethylamine, pentafluoroethylamine, perfluoropropylamine, perfluorobutylamine, perfluoropentylamine, perfluorohexylamine, perfluorooctylamine, perfluorododecylamine, perfluoropentadecylamine, perfluoroeicosylamine, 2-fluoroaniline, 3-fluoroaniline, 4-fluoroaniline, 2,6-difluoroaniline, 3,5-difluoroaniline, 2,4,6-trifluoroaniline, 3,4,5-trifluoroaniline, pentafluoroaniline, 2-(trifluoromethyl)aniline, 3-(trifluoromethyl)aniline, 4-(trifluoromethyl)aniline, 2,6-bis(trifluoromethyl)aniline, 3,5-bis(trifluoromethyl)aniline, 2,4,6-tris(trifluoromethyl)aniline, or 3,4,5-tris(trifluoromethyl)aniline; particularly preferably water, trifluoromethylamine, perfluorobutylamine, perfluorooctylamine, perfluoropentadecylamine, 2-fluoroaniline, 3-fluoroaniline, 4-fluoroaniline, 2,6-difluoroaniline, 3,5-difluoroaniline, 2,4,6-trifluoroaniline, 3,4,5-trifluoroaniline, pentafluoroaniline, 2-(trifluoromethyl)aniline, 3-(trifluoromethyl)aniline, 4-(trifluoromethyl)aniline, 2,6-bis(trifluoromethyl)aniline, 3,5-bis(trifluoromethyl)aniline, 2,4,6-tris(trifluoromethyl)aniline, or 3,4,5-tris(trifluoromethyl)aniline; and most preferably water or pentafluoroaniline.

As the granulous carrier (component (b4)), there are used preferably solid materials insoluble in a solvent used for preparing a polymerization catalyst, or a solvent used for polymerization; more preferably porous materials; further preferably inorganic materials or organic polymers; and particularly preferably inorganic materials.

The granulous carrier (component (b4)) has preferably a uniform particle diameter. Regarding a particle diameter distribution of the granulous carrier (component (b4)), a geometric standard deviation of a volume-basis particle diameter distribution of the granulous carrier (component (b4)) is preferably 2.5 or less, more preferably 2.0 or less, and further preferably 1.7 or less.

Examples of the inorganic materials of the granulous carrier (component (b4)) are inorganic oxides, clay and clay minerals, and a combination of two or more thereof.

Examples of the inorganic oxides are SiO₂, Al₂O₃, MgO, ZrO₂, TiO₂, B₂O₃, CaO, ZnO, BaO, ThO₂, SiO₂—MgO, SiO₂—Al₂O₃, SiO₂—TiO₂, SiO₂—V₂O₅, SiO₂—Cr₂O₃ and SiO₂—TiO₂—MgO, and a combination of two or more thereof. Among them, preferred is SiO₂ and/or Al₂O₃, and particularly preferred is SiO₂ (silica). The above inorganic oxides may contain a small amount of carbonates, sulfates, nitrates or oxide components such as Na₂CO₃, K₂CO₃, CaCO₃, MgCO₃, Na₂SO₄, Al₂(SO₄)₃, BaSO₄, KNO₃, Mg(NO₃)₂, Al(NO₃)₃, Na₂O, K₂O and Li₂O.

While the inorganic oxides usually have hydroxyl groups on their surfaces, active hydrogen atoms of those hydroxyl groups may be substituted with various kinds of substituents, thereby obtaining modified inorganic oxides. Such modified inorganic oxides can be used as the inorganic oxides. Examples of the modified inorganic oxides are inorganic materials obtained by contacting the inorganic oxides with trialkylchlorosilanes such as trimethylchlorosilane and tert-butyldimethylchlorosilane; triarylchlorosilanes such as triphenylchlorosilane; dialkyldichlorosilanes such as dimethyldichlorosilane; diaryldichlorosilanes such as diphenyldichlorosilane; alkyltrichlorosilanes such as methyltrichlorosilane; aryltrichlorosilanes such as phenyltrichlorosilane; trialkylalkoxysilanes such as trimethylmethoxysilane; triarylalkoxysilanes such as triphenylmethoxysilane; dialkyldialkoxysilanes such as dimethyldimethoxysilane; diaryldialkoxysilanes such as diphenyldimethoxysilane; alkyltrialkoxysilanes such as methyltrimethoxysilane; aryltrialkoxysilanes such as phenyltrimethoxysilane; tetraalkoxysilanes such as tetramethoxysilane; alkyldisilazane such as 1,1,1,3,3,3-hexamethyldisilazane; tetrachlorosilane; alcohols such as methanol and ethanol; phenol; dialkylmagnesiums such as dibutylmagnesium, butylethylmagnesium and butyloctylmagnesium; or alkyllithiums such as butyllithium.

Further examples of the inorganic oxides are those obtained according to a process comprising the steps of contacting inorganic oxides with a trialkylaluminum, thereby forming the contact product, and contacting the contact product with dialkylamines such as diethylamine and diphenylamine, alcohols such as methanol and ethanol, or phenol.

When the inorganic oxides have large strength due to hydrogen bonds formed by their hydroxyl groups, substitution of all the active hydrogen atoms in those hydroxyl groups with various kinds of substituents may decrease their strength. Therefore, it is not always necessary to substitute all the active hydrogen atoms with various kinds of substituents, and a rate of the substitution can be suitably determined. A method for controlling the substitution ratio is not particularly limited, and it can be controlled, for example, by changing an amount of a compound used for contacting with the inorganic oxides.

Examples of the clay or clay minerals are kaolin, bentonite, kibushi clay, gaerome clay, allophane, hisingerite, pyrophylite, talc, mica groups, smectite, montmorillonite groups, hectorite, raponite, saponite, vermiculite, chlorite groups, palygorskite, kaolinite, nacrite, dickite, and halloycite. Among them, preferred is smectite, montmorillonite, hectorite, raponite or saponite, and further preferred is montmorillonite or hectorite.

As the inorganic materials, there are used preferably inorganic oxides. The inorganic materials are preferably dried to contain substantially no water, and are preferably dried by heating. Inorganic materials, whose water cannot be visually confirmed, are dried by heating at usually 100 to 1,500° C., preferably 100 to 1,000° C., and further preferably 200 to 800° C. Its heating time is preferably 10 minutes to 50 hours, and more preferably 1 hour to 30 hours. Examples of a drying method by heating are a method of heating under flowing a dry inert gas (for example, nitrogen and argon) at a constant flow rate, and a method of heating under a reduced pressure.

The inorganic materials have an average particle diameter of usually 1 to 5,000 μm, preferably 5 to 1,000 μm, more preferably 10 to 500 μm, and further preferably 10 to 100 μm. Their pore volume is preferably 0.1 ml/g or more, and more preferably 0.3 to 10 ml/g. Their specific surface area is preferably 10 to 1,000 m²/g, and more preferably 100 to 500 m²/g.

The organic polymers of the granulous carrier (component (b4)) are preferably polymers containing an active hydrogen-carrying functional group, or polymers containing a non-proton-donating Lewis basic functional group.

Examples of the active hydrogen-carrying functional group are a primary amino group, a secondary amino group, an imino group, an amide group, a hydrazide group, an amidino group, a hydroxyl group, a hydroperoxy group, a carboxyl group, a formyl group, a carbamoyl group, a sulfonic acid group, a sulfinic acid group, a sulfenic acid group, a thiol group, a thioformyl group, a pyrrolyl group, an imidazolyl group, a piperidyl group, an indazolyl group, and a carbazolyl group. Among them, preferred is a primary amino group, a secondary amino group, an imino group, an amide group, an imide group, a hydroxyl group, a formyl group, a carboxyl group, a sulfonic acid group or a thiol group, and particularly preferred is a primary amino group, a secondary amino group, an amide group or a hydroxyl group. Those groups may be substituted with a halogen atom or a hydrocarbyl group having 1 to 20 carbon atoms.

The non-proton-donating Lewis basic functional group has a Lewis base portion containing no active hydrogen atom. Examples of the non-proton-donating Lewis basic functional group are a pyridyl group, an N-substituted imidazolyl group, an N-substituted indazolyl group, a nitrile group, an azido group, an N-substituted imino group, an N,N-substituted amino group, an N,N-substituted aminoxy group, an N,N,N-substituted hydrazino group, a nitroso group, a nitro group, a nitroxy group, a furyl group, a carbonyl group, a thiocarbonyl group, an alkoxy group, an alkyloxycarbonyl group, an N,N-substituted carbamoyl group, a thioalkoxy group, a substituted sulfinyl group, a substituted sulfonyl group and a substituted sulfonic acid group. Among them, preferred is a heterocyclic group, and more preferred is an aromatic heterocyclic group having an oxygen atom and/or a nitrogen atom in its ring. Particularly preferred is a pyridyl group, an N-substituted imidazolyl group or an N-substituted indazoyl group, and most preferred is a pyridyl group. Those groups may be substituted with a halogen atom or a hydrocarbyl group having 1 to 20 carbon atoms.

The organic polymer contains the active hydrogen-carrying functional group or the non-proton-donating Lewis basic functional group in a molar amount per 1 g of the organic polymer of preferably 0.01 to 50 mmol/g, and more preferably 0.1 to 20 mmol/g.

The organic polymer containing an active hydrogen-carrying functional group, or the polymers containing a non-proton-donating Lewis basic functional group can be produced, for example, by homopolymerizing a monomer having both the active hydrogen-carrying functional group and one or more polymerizable unsaturated groups, or homopolymerizing a monomer having both the non-proton-donating Lewis basic functional group and one or more polymerizable unsaturated groups, or by copolymerizing the above functional group-having monomer with other monomer having a polymerizable unsaturated group, wherein the functional group-having monomer or other monomer is preferably combined with a crosslinkable monomer having two or more polymerizable unsaturated groups.

Examples of the above polymerizable unsaturated group are alkenyl groups such as a vinyl group and an allyl group, and alkynyl groups such as an ethyne group.

Examples of the monomer having both an active hydrogen-carrying functional group and one or more polymerizable unsaturated groups are a vinyl group-containing primary amine, a vinyl group-containing secondary amine, a vinyl group-containing amide compound, and a vinyl group-containing hydroxyl compound. Specific examples thereof are N-(1-ethenyl)amine, N-(2-propenyl)amine, N-(1-ethenyl)-N-methylamine, N-(2-propenyl)-N-methylamine, 1-ethenylamide, 2-propenylamide, N-methyl-(1-ethenyl)amide, N-methyl-(2-propenyl)amide, vinyl alcohol, 2-propen-1-ol and 3-buten-1-ol.

Examples of the monomer having a non-proton-donating Lewis basic functional group and one or more polymerizable unsaturated group are vinylpyridine, vinyl(N-substituted)imidazole and vinyl(N-substituted)indazole.

Examples of the other monomer having a polymerizable unsaturated group are ethylene, α-olefins, aromatic vinyl compounds and cyclic olefins. Specific examples thereof are ethylene, propylene, 1-butene, 1-hexene, 4-methyl-1-pentene, styrene, norbornene, and dicyclopentadiene. Those monomers may be used in combination of two or more thereof. Among them, preferred is ethylene or styrene. An example of the crosslinkable monomer having two or more polymerizable unsaturated groups is divinylbenzene.

The organic polymers have an average particle diameter of usually 1 to 5,000 μm, preferably 5 to 1,000 μm, and more preferably 10 to 500 μm. Their pore volume is preferably 0.1 mL/g or more, and more preferably 0.3 to 10 mL/g. Their specific surface area is preferably 10 to 1,000 m²/g, and more preferably 50 to 500 m²/g.

The organic polymers are preferably dried to contain substantially no water, are preferably dried by heating. The organic polymers, whose water content cannot be visually confirmed, are dried by heating at usually 30 to 400° C., preferably 50 to 200° C., and further preferably 70 to 150° C. Its heating time is preferably 10 minutes to 50 hours, and more preferably 1 hour to 30 hours. Examples of a method of drying by heating are a method of heating under flowing a dry inert gas (for example, nitrogen and argon) at a constant flow rate, and a method of heating under a reduced pressure.

The component (B) is formed by contacting the components (b1), (b2), (b3) and (b4) with one another. Examples of a contact order in contacting those components with one another are as follows:

<1> a contact order comprising the steps of contacting the component (b1) with the component (b2) to produce a first contact product, then contacting the first contact product with the component (b3) to produce a second contact product, and then, contacting the second contact product with the component (b4);

<2> a contact order comprising the steps of contacting the component (b1) with the component (b2) to produce a first contact product, then contacting the first contact product with the component (b4) to produce a second contact product, and then, contacting the second contact product with the component (b3);

<3> a contact order comprising the steps of contacting the component (b1) with the component (b3) to produce a first contact product, then contacting the first contact product with the component (b2) to produce a second contact product, and then, contacting the second contact product with the component (b4);

<4> a contact order comprising the steps of contacting the component (b1) with the component (b3) to produce a first contact product, then contacting the first contact product with the component (b4) to produce a second contact product, and then, contacting the second contact product with the component (b2);

<5> a contact order comprising the steps of contacting the component (b1) with the component (b4) to produce a first contact product, then contacting the first contact product with the component (b2) to produce a second contact product, and then, contacting the second contact product with the component (b3);

<6> a contact order comprising the steps of contacting the component (b1) with the component (b4) to produce a first contact product, then contacting the first contact product with the component (b3) to produce a second contact product, and then, contacting the second contact product with the component (b2);

<7> a contact order comprising the steps of contacting the component (b2) with the component (b3) to produce a first contact product, then contacting the first contact product with the component (b1) to produce a second contact product, and then, contacting the second contact product with the component (b4);

<8> a contact order comprising the steps of contacting the component (b2) with the component (b3) to produce a first contact product, then contacting the first contact product with the component (b4) to produce a second contact product, and then, contacting the second contact product with the component (b1);

<9> a contact order comprising the steps of contacting the component (b2) with the component (b4) to produce a first contact product, then contacting the first contact product with the component (b1) to produce a second contact product, and then, contacting the second contact product with the component (b3);

<10> a contact order comprising the steps of contacting the component (b2) with the component (b4) to produce a first contact product, then contacting the first contact product with the component (b3) to produce a second contact product, and then, contacting the second contact product with the component (b1);

<11> a contact order comprising the steps of contacting the component (b3) with the component (b4) to produce a first contact product, then contacting the first contact product with the component (b1) to produce a second contact product, and then, contacting the second contact product with the component (b2); and

<12> a contact order comprising the steps of contacting the component (b3) with the component (b4) to produce a first contact product, then contacting the first contact product with the component (b2) to produce a second contact product, and then, contacting the second contact product with the component (b1).

The components (b1) to (b4) are contacted with one another preferably in an atmosphere of an inert gas; at usually −100 to 300° C., and preferably −80 to 200° C.; for usually 1 minute to 200 hours, and preferably 10 minutes to 100 hours; and with or without a solvent.

When using solvents, the solvents need to be inert to the components (b1) to (b4) and the contact products thereof. However, when respective components are mutually contacted stepwise as mentioned above, even solvents reactive with some component in some contacting step can be used in other contacting step, provided that those solvents are inert to respective components in the other contacting step. Namely, solvents used in the respective contacting steps are the same as, or different from one another. Examples of the solvent are non-polar solvents such as aliphatic hydrocarbons and aromatic hydrocarbons; and polar solvents such as halides, ethers, alcohols, phenols, carbonyl compounds, phosphoric acid derivatives, nitrile compounds, nitro compounds, amines, and sulfur compounds. Specific examples thereof are aliphatic hydrocarbons such as butane, pentane, hexane, heptane, octane, 2,2,4-trimethylpentane and cyclohexane; aromatic hydrocarbons such as benzene, toluene and xylene; halides such as dichloromethane, difluoromethane, chloroform, 1,2-dichloroethane, 1,2-dibromoethane, 1,1,2-trichloro-1,2,2-trifluoroethane, tetrachloroethylene, chlorobenzene, bromobenzene and o-dichlorobenzene; ethers such as dimethyl ether, diethyl ether, diisopropyl ether, di-n-butyl ether, methyl-tert-butyl ether, anisole, 1,4-dioxane, 1,2-dimethoxyethane, bis(2-methoxyethyl)ether, tetrahydrofuran and tetrahydropyran; alcohols such as methanol, ethanol, 1-propanol, 2-propanol, 1-butanol, 2-butanol, 2-methyl-1-propanol, 3-methyl-1-butanol, cyclohexanol, benzylalcohol, ethylene glycol, propylene glycol, 2-methoxyethanol, 2-ethoxyethanol, diethyleneglycol, triethyleneglycol, and glycerine; phenols such as phenol and p-cresol; carbonyl compounds such as acetone, ethyl methyl ketone, cyclohexanone, acetic anhydride, ethyl acetate, butyl acetate, ethylene carbonate, propylene carbonate, N,N-dimethylformamide, N,N-dimethylacetamide and N-methyl-2-pyrrolidone; phosphoric acid derivatives such as hexamethylphosphate triamide and triethyl phosphate; nitrile compounds such as acetonitrile, propionitrile, succinonitrile and benzonitrile; nitro compounds such as nitromethane and nitrobenzene; amines such as pyridine, piperidine and morpholine; and sulfur compounds such as dimethylsulfoxide and sulfolane.

In case of contacting the contact product (referred to hereinafter as “contact product (c)”) among the components (b1) to (b3) with the component (b4), namely in case of the above contact order <1>, <3> or <7>, the contact product (c) is prepared in a solvent (referred to hereinafter as “solvent (s1)”) of preferably the above aliphatic hydrocarbons, aromatic hydrocarbons or ethers.

On the other hand, the contact product (c) and the component (b4) are contacted with each other in a solvent (referred to hereinafter as “solvent (s2)”) of preferably polar solvents. One example of an index indicating polarity of solvents is an E_{T}^{N} value disclosed in C. Reichardt, “Solvents and Solvents Effects in Organic Chemistry”, 2nd ed., VCH Verlag (1988). The solvent (s2) is particularly preferably a solvent having an E_{T}^{N} value of 0.1 to 0.8.

Examples of the solvent (s2) having such an E_{T}^{N} value range are dichloromethane, dichlorodifluoromethane, chloroform, 1,2-dichloroethane, 1,2-dibromoethane, 1,1,2-trichloro-1,2,2-trifluoroethane, tetrachloroethylene, chlorobenzene, bromobenzene, o-dichlorobenzene, dimethyl ether, diethyl ether, diisopropyl ether, di-n-butyl ether, methyl-tert-butyl ether, anisole, 1,4-dioxane, 1,2-dimethoxyethane, bis(2-methoxyethyl)ether, tetrahydrofuran, tetrahydropyran, methanol, ethanol, 1-propanol, 2-propanol, 1-butanol, 2-butanol, 2-methyl-1-propanol, 3-methyl-1-butanol, cyclohexanol, benzylalcohol, ethylene glycol, propylene glycol, 2-methoxyethanol, 2-ethoxyethanol, diethyleneglycol, triethyleneglycol, acetone, ethyl methyl ketone, cyclohexanone, acetic anhydride, ethyl acetate, butyl acetate, ethylene carbonate, propylene carbonate, N,N-dimethylformamide, N,N-dimethylacetamide, N-methyl-2-pyrrolidone, hexamethylphosphate triamide, triethyl phosphate, acetonitrile, propionitrile, succinonitrile, benzonitrile, nitromethane, nitrobenzene, ethylene diamine, pyridine, piperidine, morpholine, dimethylsulfoxide and sulfolane.

The solvent (s2) is further preferably dimethyl ether, diethyl ether, diisopropyl ether, di-n-butyl ether, methyl-tert-butyl ether, anisole, 1,4-dioxane, 1,2-dimethoxyethane, bis(2-methoxyethyl)ether, tetrahydrofuran, tetrahydropyran, methanol, ethanol, 1-propanol, 2-propanol, 1-butanol, 2-butanol, 2-methyl-1-propanol, 3-methyl-1-butanol, cyclohexanol, benzylalcohol, ethylene glycol, propylene glycol, 2-methoxyethanol, 2-ethoxyethanol, diethyleneglycol or triethyleneglycol; particularly preferably di-n-butyl ether, methyl-tert-butyl ether, 1,4-dioxane, tetrahydrofuran, methanol, ethanol, 1-propanol, 2-propanol, 1-butanol, 2-butanol, 2-methyl-1-propanol, 3-methyl-1-butanol or cyclohexanol; and most preferably tetrahydrofuran, methanol, ethanol, 1-propanol or 2-propanol.

The above solvent (s2) may be a mixed solvent of those polar solvents with hydrocarbon solvents. The hydrocarbon solvents are those exemplified above as the aliphatic hydrocarbon solvents and the aromatic hydrocarbon solvents. Examples of the mixed solvent of polar solvents with hydrocarbon solvents are the following combinations: hexane/methanol, hexane/ethanol, hexane/1-propanol, hexane/2-propanol, heptane/methanol, heptane/ethanol, heptane/1-propanol, heptane/2-propanol, toluene/methanol, toluene/ethanol, toluene/1-propanol, toluene/2-propanol, xylene/methanol, xylene/ethanol, xylene/1-propanol, and xylene/2-propanol. Among them, the combination is preferably hexane/methanol, hexane/ethanol, heptane/methanol, heptane/ethanol, toluene/methanol, toluene/ethanol, xylene/methanol or xylene/ethanol; further preferably hexane/methanol, hexane/ethanol, toluene/methanol toluene/ethanol; and most preferably toluene/ethanol. The toluene/ethanol mixed solvent contains preferably 10 to 50% by volume of ethanol, and further preferably 15 to 30% by volume of ethanol.

In case of contacting the contact product (c) among the components (b1) to (b3) with the component (b4), namely in case of the above contact order <1>, <3> or <7>, both the solvent (s1) and the solvent (s2) may be hydrocarbon solvents. In this case, a short time interval is preferable between completion of the contact among the components (b1) to (b3) and beginning of the contact of the contact product (c) with the component (b4). The time interval is preferably 0 to 5 hours, further preferably 0 to 3 hours, and most preferably 0 to 1 hour. The contact product (c) is contacted with the component (b4) at usually −100 to 40° C., preferably −20 to 20° C., and most preferably −10 to 10° C.

The above contact orders <2>, <5> to <6>, and <8> to <12> can be carried out in either non-polar solvents or polar solvents mentioned above. Among them, preferred are non-polar solvents for the following possible reasons. The contact product between the component (b1) and the component (b3), and the contact product between the component (b3) and the previously-formed contact product of the component (b1) with the component (b2) generally have such a low solubility in non-polar solvents that those contact products are apt to be precipitated and supported on the surface of the component (b4) existing in a reaction system at the time of formation of those contact products.

The components (b2) and (b3) are used preferably in an amount satisfying the following formula (I), per 1 mol of the component (b1):

|valence of M³−molar amount of component (b2)−2×molar amount of compound (b3)|≦1 (I)

wherein the molar amount of the component (b2) is preferably 0.01 to 1.99 mol, more preferably 0.1 to 1.8 mol, further preferably 0.2 to 1.5 mol, and most preferably 0.3 to 1 mol, per 1 mol of the component (b1). Preferable, more preferable, further preferable and most preferable molar amounts of the component (b3) per 1 mol of the component (b1) are calculated, respectively, by assigning the valence of the the above respective molar amounts of the component (b2) per 1 mol of the component (b1), and the above the formula (I).

Each of the component (b1) and the component (b2) is used in an amount such that a molar amount of the metal atom derived from the component (b1) contained in 1 g of the component (B) is preferably 0.1 mmol or more, and more preferably 0.5 to 20 mmol.

In order to promote the reaction, the finally contacting steps in the above contact orders may be followed by an additional heating step carried out at a higher temperature. The heating step is carried out preferably using a solvent having a high boiling point in order to proceed with the reaction at a higher temperature. To that end, the solvent used in the former contacting step may be replaced with other solvent having a higher boiling point than that of the former solvent.

The component (B) produced by the above contact orders may contain the components (b1), (b2), (b3) or (b4) as unreacted starting materials. Those unreacted starting materials, however, are preferably washed away from the component (B) with a solvent. The washing solvent is the same as, or different from those used in the respective contacting steps of the above contact orders. The washing is carried out preferably in an atmosphere of an inert gas, at usually −100 to 300° C., and preferably −80 to 200° C., for usually 1 minute to 200 hours, and preferably 10 minutes to 100 hours.

After the above finally contacting step or washing, the resultant product is preferably subjected to distillation away of a solvent contained therein, and then, is preferably dried under a reduced pressure preferably at 0° C. or higher for 1 to 24 hours, more preferably at 0 to 200° C. for 1 to 24 hours, further preferably at 10 to 200° C. for 1 to 24 hours, particularly preferably at 10 to 160° C. for 2 to 18 hours, and most preferably at 15 to 160° C. for 4 to 18 hours.

In contacting the components (A1), (A2) and (B) with one another, the component (A1) is used in an amount of usually 1 to 90 mol, per one mol of the component (A2).

The total of the components (A1) and (A2) is used in an amount of preferably 1 to 10,000 μmol/g, more preferably 10 to 1,000 μmol/g, and further preferably 20 to 500 μmol/g, per one gram of the component (B).

In preparing the polymerization catalyst, an organoaluminum compound (component (C)) may further be contacted with the component (A1), (A2) or (B). The component (C) is used in an amount of preferably 0.1 to 1,000 mol, more preferably 0.5 to 500 mol, and further preferably 1 to 100 mol, in terms of a molar amount of aluminum atoms contained in the component (C), per one mol of the total of the components (A1) and (A2).

Examples of the component (C) are trialkylaluminums such as trimethylaluminum, triethylaluminum, tri-n-propylaluminum, tri-n-butylaluminum, triisobutylaluminum, tri-n-hexylaluminum and tri-n-octylaluminum; dialkylaluminum chlorides such as dimethylaluminum chloride, diethylaluminum chloride, di-n-propylaluminum chloride, di-n-butylaluminum chloride, diisobutylaluminum chloride and di-n-hexylaluminum chloride; alkylaluminum dichlorides such as methylaluminum dichloride, ethylaluminum dichloride, n-propylaluminum dichloride, n-butylaluminum dichloride, isobutylaluminum dichloride and n-hexylaluminum dichloride; dialkylaluminum hydrides such as dimethylaluminum hydride, diethylaluminum hydride, di-n-propylaluminum hydride, di-n-butylaluminum hydride, diisobutylaluminum hydride and di-n-hexylaluminum hydride; alkyl(dialkoxy)aluminums such as methy(dimethoxy)aluminum, methyl(diethoxy)aluminum and methyl(di-tert-butoxy)aluminum; dialkyl(alkoxy)aluminums such as dimethy(methoxy)aluminum, dimethyl(ethoxy)aluminum and dimethyl(tert-butoxy)aluminum; alkyl(diaryloxy)aluminums such as methyl(diphenoxy)aluminum, methylbis(2,6-diisopropylphenoxy)aluminum and methylbis(2,6-diphenylphenoxy)aluminum; and dialkyl(aryloxy)aluminums such as dimethyl(phenoxy)aluminum, dimethyl(2,6-diisopropylphenoxy)aluminum and dimethyl(2,6-diphenylphenoxy)aluminum. Those organoaluminum compounds may be used in combination of two or more thereof.

Among them, preferred are trialkylaluminums; more preferred is trimethylaluminum, triethylaluminum, tri-n-butylaluminum, triisobutylaluminum, tri-n-hexylaluminum or tri-n-octylaluminum; and further preferred is triisobutylaluminum or tri-n-octylaluminum.

Also, in preparing the polymerization catalyst, an electron donor compound (component (D)) may further be contacted with the component (A1), (A2) or (B). The component (D) is used in an amount of preferably 0.01 to 100 mol, more preferably 0.1 to 50 mol, and further preferably 0.25 to 5 mol, per one mol of the total of the components (A1) and (A2).

Examples of the component (D) are triethylamine and tri-n-octylamine.

The components (A1), (A2) and (B) and the optional components (C) and (D) are contacted with one another in an atmosphere of an inert gas; at usually −100 to 300° C., and preferably −80 to 200° C.; and for usually 1 minute to 200 hours, and preferably 10 minutes to 100 hours. Those components may be put separately in a polymerization reactor, thereby contacting them with one another in the polymerization reactor.

The process for producing an olefin polymer of the present invention comprises the step of polymerizing an olefin in the presence of the above olefin polymerization catalyst.

Examples of a method for polymerizing an olefin are a gas phase polymerization method, a slurry polymerization method, and a bulk polymerization method. Among them, preferred is a gas phase polymerization method, and more preferred is a continuous gas phase polymerization method. A gas phase polymerization reactor used for the gas phase polymerization method is usually a fluidized-bed reactor, and preferably a fluidized-bed reactor having an expanded part therein. The fluidized-bed reactor may have an agitator therein.

The polymerization catalyst and respective catalyst components are usually fed to the polymerization reactor under a water-free condition, together with a gas such as an inert gas (for example, nitrogen and argon), a hydrogen gas and an ethylene gas, or are usually fed thereto in their solution or slurry state obtained by dissolving or diluting them in a solvent.

Olefins are polymerized in a gas phase usually at a temperature lower than a melting point of olefin polymers obtained, preferably at 0 to 150° C., and more preferably at 30 to 100° C. The polymerization reactor may be supplied with an inert gas, or may be supplied with a hydrogen gas as a molecular weight regulator, or may be supplied with the organoaluminum compound or electron donor compound.

Examples of the olefin used for polymerization are olefins having 2 to 20 carbon atoms such as ethylene, propylene, 1-butene, 1-pentene, 1-hexene, 1-heptene, 1-octene, 1-nonene, 1-decene, 1-dodecene, 4-methyl-1-pentene, and 4-methyl-1-hexene. These olefins can be used alone, or are used in combination of two or more thereof. Among them, preferred is ethylene, 1-butene, 1-hexene, 4-methyl-1-pentene, or 1-octene.

The process for producing an olefin polymer of the present invention is preferable for copolymerizing ethylene with an α-olefin having 3 to 20 carbon atoms. Examples of a combination of ethylene with the α-olefin are ethylene/1-butene, ethylene/1-hexene, ethylene/4-methyl-1-pentene, ethylene/1-octene, ethylene/1-butene/1-hexene, ethylene/1-butene/4-methyl-1-pentene, ethylene/1-butene/1-octene, and ethylene/1-hexene/1-octene. Among them, preferred is ethylene/1-hexene, ethylene/4-methyl-1-pentene, ethylene/1-butene/1-hexene, ethylene/1-butene/1-octene, or ethylene/1-hexene/1-octene.

If necessary, those olefins may be copolymerized with other monomers supplied to the polymerization reactor, as long as such an embodiment does not disturb the effect of the present invention. Examples of the other monomers are diolefins, cyclic olefins, alkenyl aromatic hydrocarbons and α,β-unsaturated carboxylic acids.

Specific examples thereof are diolefins such as 1,5-hexadiene, 1,4-hexadiene, 1,4-pentadiene, 1,7-octadiene, 1,8-nonadiene, 1,9-decadiene, 4-methyl-1,4-hexadiene, 5-methyl-1,4-hexadiene, 7-methyl-1,6-octadiene, 5-ethylidene-2-norbornene, dicyclopentadiene, 5-vinyl-2-norbornene, 5-methyl-2-norbornene, norbornadiene, 5-methylene-2-norbornene, 1,5-cyclooctadiene, 5,8-endomethylenehexahydronaphthalene, 1,3-butadiene, isoprene, 1,3-hexadinene, 1,3-octadiene, 1,3-cyclooctadiene and 1,3-cyclohexadiene; cyclic olefins such as cyclopentene, cyclohexene, norbornene, 5-methylnorbornene, 5-ethylnorbornene, 5-butylnorbornene, 5-phenylnorbornene, 5-benzylnorbornene, tetracyclododecene, tricyclodecene, tricycloundecene, pentacyclopentadecene, pentacyclohexadecene, 8-methyltetracyclododecene, 8-ethyltetracyclodecene, 5-acetylnorbornene, 5-acetyloxynorbornene, 5-methoxycarbonylnorbornene, 5-ethoxycarbonylnorbornene, 5-methyl-5-methoxycarbonylnorbornene, 5-cyanonorbornene, 8-methoxycarbonyltetracyclododecene, 8-methyl-8-tetracyclododecene and 8-cyanotetracyclododecene; alkenylaromatic hydrocarbons such as alkenylbenzenes (e.g. styrene, 2-phenylpropylene, 2-phenylbutene and 3-phenylpropylene), alkylstyrenes (e.g. p-methylstyrene, m-methylstyrene, o-methylstyrene, p-ethylstyrene, m-ethylstyrene, o-ethylstyrene, 2,4-dimethylstyrene, 2,5-dimethylstyrene, 3,4-dimethylstyrene, 3,5-dimethylstyrene, 3-methyl-5-ethylstyrene, p-tert-butylstyrene and p-sec-butylstyrene), bisalkenylbenzenes (e.g. divinylbenzene) and alkenylnaphthalenes (e.g. 1-vinylnaphthalene); α,β-unsaturated carboxylic acids such as acrylic acid, methacrylic acid, fumaric acid, maleic anhydride, itaconic acid, itaconic anhydride and bicyclo(2,2,1)-5-heptene-2,3-dicarboxylic acid; salts of those α,β-unsaturated carboxylic acids with metals such as sodium, potassium, lithium, zinc, magnesium and calcium; alkyl esters of those α,β-unsaturated carboxylic acids such as methyl acrylate, ethyl acrylate, n-propyl acrylate, isopropyl acrylate, tert-butyl acrylate, 2-ethylhexyl acrylate, methyl methacrylate, ethyl methacrylate, n-propyl methacrylate, isopropyl methacrylate, n-butyl methacrylate and isobutyl methacrylate; unsaturated dicarboxylic acids such as maleic acid and itaconic acid; vinyl esters such as vinyl acetate, vinyl propionate, vinyl caproate, vinyl caprate, vinyl laurate, vinyl stearate and vinyl trifluoroacetate; and unsaturated carboxylic acid glycidyl esters such as glycidyl acrylate, glycidyl methacrylate and monoglycidyl itaconate.

The process for producing an olefin polymer of the present invention comprises preferably the steps of polymerizing a small amount of an olefin using the components (A1), (A2), (B), and optionally-used organoaluminum compound and electron donor compound, thereby obtaining a pre-polymerized solid component (referred to hereinafter as pre-polymerization), and polymerizing an olefin using the pre-polymerized solid component as a polymerization catalyst component or a polymerization catalyst.

Examples of the olefin used in the pre-polymerization are ethylene, propylene, 1-butene, 1-pentene, 1-hexene, 1-octene, 4-methyl-1-pentene, cyclopentene, and cyclohexene. Those olefins can be used alone, or are used in combination of two or more thereof. Among them, preferred is ethylene only, or a combination of ethylene with an α-olefin, and further preferred is ethylene only, or a combination of ethylene with one or more α-olefins selected from the group consisting of 1-butene, 1-hexene and 1-octene.

The pre-polymerized solid component contains a pre-polymerized polymer in an amount of preferably 0.01 to 1,000 g, more preferably 0.05 to 500 g, and further preferably 0.1 to 200 g, per one gram of the component (B).

The pre-polymerization may be carried out according to a continuous polymerization method or a batchwise polymerization method, and examples thereof are a batchwise slurry polymerization method, a continuous slurry polymerization method, and a continuous gas-phase polymerization method.

The components (A1), (A2) and (B) and optionally the organoaluminum compound and electron donor compound are usually fed to a pre-polymerization reactor under a water-free condition, together with a gas such as an inert gas (for example, nitrogen and argon), a hydrogen gas and an ethylene gas, or are usually fed thereto in their solution or slurry state obtained by dissolving or diluting them in a solvent.

When the pre-polymerization is carried out according to a slurry polymerization method, saturated aliphatic hydrocarbon compounds are usually used as a solvent, and examples thereof are propane, n-butane, isobutane, n-pentane, isopentane, n-hexane, cyclohexane, and heptane. Those compounds are used alone or in combination of two or more thereof. The saturated aliphatic hydrocarbon compounds are preferably those having a boiling point of 100° C. or lower under a ordinary pressure, more preferably those having a boiling point of 90° C. or lower under a ordinary pressure, and further preferably propane, n-butane, isobutane, n-pentane, isopentane, n-hexane or cyclohexane.

Also, when the pre-polymerization is carried out according to a slurry polymerization method, the slurry contains the component (B) in an amount of usually 0.1 to 600 g, and preferably 0.5 to 300 g, per one liter of a solvent. A pre-polymerization temperature is usually −20 to 100° C., and preferably 0 to 80° C., and may be suitably changed during the pre-polymerization. A partial pressure of an olefin in a gas phase of the pre-polymerization is usually 0.001 to 2 MPa, and preferably 0.01 to 1 MPa. A pre-polymerization time is usually 2 minutes to 15 hours.

The pre-polymerized solid catalyst component is usually fed to a polymerization reactor under a water-free condition, together with a gas such as an inert gas (for example, nitrogen and argon), a hydrogen gas and an ethylene gas, or is usually fed thereto in its solution or slurry state obtained by dissolving or diluting it in a solvent.

Examples of the olefin polymer obtained by the process for producing an olefin polymer of the present invention are ethylene homopolymers and copolymers of ethylene with α-olefins having 3 to 20 carbon atoms. Examples of the copolymers of ethylene with α-olefins having 3 to 20 carbon atoms are ethylene-1-butene copolymers, ethylene-1-hexene copolymers, ethylene-4-methyl-1-pentene copolymers, ethylene-1-octene copolymers, ethylene-1-butene-1-hexene copolymers, ethylene-1-butene-4-methyl-1-pentene, copolymers, ethylene-1-butene-1-octene copolymers, and ethylene-1-hexene-1-octene copolymers. Among them, preferred are copolymers of ethylene with α-olefins having 3 to 20 carbon atoms, and more preferred are ethylene-1-hexene copolymers, ethylene-4-methyl-1-pentene copolymers, ethylene-1-butene-1-hexene copolymers, ethylene-1-butene-1-octene copolymers, or ethylene-1-hexene-1-octene copolymers.

The olefin polymer in the present invention has a density (hereinafter referred to as “d”) of usually 860 to 960 kg/m³, and from a viewpoint of obtaining molded articles having high mechanical strength, preferably 950 kg/m³ or smaller, more preferably 940 kg/m³ or smaller, and further preferably 930 kg/m³ or smaller. Also, from a viewpoint of obtaining molded articles having high stiffness, the density is preferably 870 kg/m³ or larger, more preferably 880 kg/m³ or larger, further preferably 890 kg/m³ or larger, and particularly preferably 900 kg/m³ or larger. The density is determined according to a method comprising the steps of annealing according to the method described in JIS K6760-1995, and then measuring according to the method A described in JIS K7112-1980.

The olefin polymer in the present invention contains monomer units based on ethylene in an amount of preferably 50% by weight or more, the total weight of the olefin polymer being 100% by weight.

The olefin polymer in the present invention has a melt flow rate (hereinafter referred to as “MFR”) of usually 0.01 to 100 g/10 minutes. From a viewpoint of enhancing its molding processability, and particularly from a viewpoint of decreasing an extrusion loading at the time of a molding process, its MFR is preferably 0.05 g/10 minutes or larger, and more preferably 0.1 g/10 minutes or larger. Also, from a viewpoint of obtaining molded articles having high mechanical strength, its MFR is preferably 50 g/10 minutes or smaller, and more preferably 20 g/10 minutes or smaller. The MFR is measured at 190° C. under a load of 21.18 N according to the method A of JIS K7210-1995. The MFR can be controlled, for example, by changing a hydrogen concentration or a polymerization temperature. The higher the hydrogen concentration or the polymerization temperature is, the larger the MFR is.

When producing copolymers of ethylene with α-olefins having 3 to 20 carbon atoms according to the process for producing an olefin polymer of the present invention, the following three kinds of ethylene-α-olefin copolymers can be produced separately depending on their manufacturing conditions:

1) ethylene-α-olefin copolymers (hereinafter referred to as “polymer 1”) having monomer units based on ethylene and monomer units based on an α-olefin having 3 to 20 carbon atoms, a density (d) of 860 to 950 kg/m³, a melt flow rate (MFR) of 1 to 100 g/10 minutes, a flow activation energy (Ea) of 60 kJ/mol or more, a ratio (Mw/Mn) of a weight average molecular weight (Mw) to a number average molecular weight (Mn) of 5.5 to 30, a ratio (Mz/Mw) of a Z average molecular weight (Mz) to a weight average molecular weight (Mw) of 2 to 5, and a swelling ratio (SR) of 1.55 or more but less than 1.8;

2) ethylene-α-olefin copolymers (hereinafter referred to as “polymer 2”) having monomer units based on ethylene and monomer units based on an α-olefin having 3 to 20 carbon atoms, a density (d) of 860 to 950 kg/m³, a melt flow rate (MFR) of 1 to 100 g/10 minutes, a ratio (Mw/Mn) of a weight average molecular weight (Mw) to a number average molecular weight (Mn) of 4 to 30, a ratio (Mz/Mw) of a Z average molecular weight (Mz) to a weight average molecular weight (Mw) of 2 to 5, a swelling ratio (SR) of 1.8 or more, and a characteristic relaxation time (τ) of 0.01 to 10 seconds obtained by a linear viscoelastic measurement; and

3) ethylene-α-olefin copolymers (hereinafter referred to as “polymer 3”) having monomer units based on ethylene and monomer units based on an α-olefin having 3 to 20 carbon atoms, a density (d) of 860 to 950 kg/m³, a melt flow rate (MFR) of 0.01 g/10 minutes or more but less than 1 g/10 minutes, a ratio (Mw/Mn) of a weight average molecular weight (Mw) to a number average molecular weight (Mn) of 4 to 30, a ratio (Mz/Mw) of a Z average molecular weight (Mz) to a weight average molecular weight (Mw) of 2 to 5, and a melt tension (MT) of 12 cN or more.

The polymer 1 can be produced according to a process comprising the step of copolymerizing ethylene with an α-olefin having 3 to 20 carbon atoms in the presence of an olefin polymerization catalyst formed by contacting 40 to 90 parts by mol of the component (A1), one part by mol of the component (A2) and the component (B) with one another. The component (A1) is used in an amount of preferably 50 to 80 parts by mol per one part by mol of the component (A2), from a viewpoint of enhancing a withdrawing property of the polymer 1 in a molten state at the time of extrusion molding thereof.

The polymer 2 can be produced according to a process comprising the step of copolymerizing ethylene with an α-olefin having 3 to 20 carbon atoms in the presence of an olefin polymerization catalyst formed by contacting 1 to 30 parts by mol of the component (A1), one part by mol of the component (A2) and the component (B) with one another. From a viewpoint of decreasing a relaxation time of molecular chains of the polymer 2 in its molten state, and increasing mechanical strength thereof, the component (A1) is contacted with one part by mol of the component (A2) in an amount of preferably 5 parts by mol or larger, and more preferably 10 parts by mol or larger. Also, from a viewpoint of increasing a swelling ratio (SR) of the polymer 2, the component (A1) is contacted with one part by mol of the component (A2) in an amount of preferably 20 parts by mol or smaller.

The polymer 3 can be produced according to a process comprising the step of copolymerizing ethylene with an α-olefin having 3 to 20 carbon atoms in the presence of an olefin polymerization catalyst formed by contacting 0.5 to 30 parts by mol of the component (A1), one part by mol of the component (A2) and the component (B) with one another, such that the polymer 3 has a melt flow rate (MFR) of 0.01 g/10 minutes or more but less than 1 g/10 minutes. From a viewpoint of decreasing an extrusion load of the polymer 3 in its molten state, and increasing mechanical strength thereof, the component (A1) is contacted with one part by mol of the component (A2) in an amount of preferably one part by mol or larger. Also, from a viewpoint of increasing an MT of the polymer 2, the component (A1) is contacted with one part by mol of the component (A2) in an amount of preferably 20 parts by mol or smaller, and more preferably 9 parts by mol or smaller.

Olefin polymers obtained according to the process for producing an olefin polymer of the present invention are excellent in their molding processability such as extrusion load during a molding process, bubble stability during a blown film process, neck-in during a T-die film process, and a shape-retention of a parison during a blow molding process, and excellent in their mechanical strength. Also, they can be excellent in their transparency of molded articles thereof.

Those olefin polymers are molded according to a molding process known in the art such as an extrusion molding process (for example, a blown film process and a T-die film process), a blow molding process, an injection molding process, and a compression molding process. Among them, preferred is an extrusion molding process or a blow molding process, and particularly preferred is a blown film process, a T-die film process or a blow molding process.

Those olefin polymers are molded into various shapes, and then are used. Those shapes of molded articles are not particularly limited, and examples thereof are films, sheets, and containers such as trays and bottles. Those molded articles are preferably applied to uses such as surface protecting materials and packing materials for foods, medical products or electronic parts (for example, semiconductor products).

The present invention is explained according to the following Examples and Comparative Examples.

Physical properties in those Examples and Comparative Examples were measured according to the following methods.

(1) Density (d, unit: Kg/m³)

It was measured according to the method (A) prescribed in JIS K7112-1980 with a sample annealed according to JIS K6760-1995.

(2) Melt Flow Rate (MFR, unit: g/10minutes)

It was measured according to the method (A) prescribed in JIS K7210-1995 at 190° C. under a load of 21.18 N.

### (3) Swelling Ratio (SR)

It was measured according to a method comprising the steps of:

extruding an ethylene-α-olefin copolymer through an orifice at 190° C. under a load of 21.18 N in the measurement of the melt flow rate mentioned in the above section (2), thereby obtaining a strand having a strength of about 15 to 20 mm;

cooling the strand in air, thereby obtaining a solid strand;

measuring a diameter (D, unit: mm) of the strand at its position of about 5 mm far from the upstream end of the extrusion; and

dividing the diameter D by the orifice diameter (D₀=2.095 mm), thereby obtaining a swelling ratio (D/D₀).

### (4) Molecular Weight Distribution (Mw/Mn and Mz/Mw)

Mz (z-average molecular weight), Mw (weight-average molecular weight) and Mn (number-average molecular weight) were measured according to a gel permeation chromatography (GPC) under the following conditions (1) to (8), and then Mw/Mn and Mz/Mw were obtained:

(1) apparatus: WATERS 150C manufactured by Waters Corporation;

(2) separating column: TSK gel GMH 6-HT manufactured by Tosoh Corporation;

(3) measurement temperature: 140° C.;

(4) carrier: o-dichlorobenzene;

(5) flow rate: 1.0 mL/minute;

(6) injection volume: 500 μL;

(7) detector: differential refractometer; and

(8) molecular standard material: standard polystyrene;

wherein a base line on the chromatogram was a straight line made by connecting one point to another point, the former point existing in a stable and horizontal region having a completely short retention time before appearance of a sample elusion peak, and the latter point existing in a stable and horizontal region having a completely long retention time after observation of a solvent elusion peak.
(5) Activation Energy of Flow (Ea, unit: kJ/mol)

It was obtained according to a method comprising the steps of:

measuring a melt complex viscosity-angular frequency curve under the following measurement conditions at 130° C., 150° C., 170° C. and 190° C., respectively, with a viscoelasticity measuring equipment, RHEOMETRICS MECHANICAL SPECTROMETER RMS-800, manufactured by Rheometrics Scientific Inc.;

preparing a master curve of the melt complex viscosity-angular frequency curve at 190° C. from the above-obtained melt complex viscosity-angular frequency curve, using a computational software, RHIOS V.4.4.4 manufactured by Rheometrics Scientific Inc.; and

obtaining an activation energy (Ea) from the master curve;

### <Measurement Conditions>

geometry: parallel plate,

plate diameter: 25 mm.

plate clearance: 1.5 to 2 mm,

strain: 5%,

angular frequency: 0.1 to 100 rad/second, and

measurement atmosphere: nitrogen.

(6) Melt Complex Viscosity (η*, unit: Pa·sec)

It was measured at 190° C. and at an angular frequency of 100 rad/second in the above section (5). The smaller the melt complex viscosity is, the better extrusion molding is in its extrusion load.

(7) Melt Tension (MT, unit: cN)

It was measured according to a method comprising the steps of:
melt extruding an ethylene-α-olefin copolymer through an orifice having a diameter of 2.095 mm and a length of 8 mm at 190° C. and an extrusion speed of 0.32 g/minute, using a melt tension tester manufactured by Toyo Seiki Seisaku-sho, Ltd.; and

pulling the extruded molten ethylene-α-olefin copolymer with a pulling roll in a filament shape at a pulling ascent velocity of 6.3 (m/minute)/minute; and

measuring its tensile force;

wherein the melt tension was defined as the largest tensile force observed between the beginning of the pulling and the break of the filament-shaped ethylene-α-olefin copolymer.
(8) Maximum Tensile Velocity (MTV, unit: m/minute)

It was defined as a pulling velocity in the above section (7), at which the filament-shaped ethylene-α-olefin copolymer was broken. The higher the MTV value is, the better extrusion molding is in its pulling property.

### EXAMPLE 1

### (1) Preparation of Solid Catalyst Component (B)

A reactor equipped with an agitator was purged with nitrogen. There were put in the reactor 2.8 kg of silica (Sylopol 948 manufactured by Davison Co., Ltd.; 50% volume average particle diameter=55 μm; pore volume=1.67 ml/g; and specific surface area=325 m²/g), which silica had been previously heated at 300° C. under a nitrogen gas flow, and 24 kg of toluene, and the resultant mixture was agitated. Then, the mixture was cooled down to 5° C., and a mixed solution of 0.9 kg of 1,1,1,3,3,3-hexamethyldisilazane with 1.4 kg of toluene was added drop-wise over 30 minutes to the cooled mixture at 5° C. maintained. After completion of the drop-wise addition, the mixture was agitated at 5° C. for 1 hour, and then was heated up to 95° C., and was agitated at 95° C. 3 hours. The mixture was filtered, and the obtained solid product was washed six times with each 20.8 kg of toluene. There was added 7.1 kg of toluene to the washed solid product, thereby obtaining a slurry, which was allowed to stand overnight.

To the above-obtained slurry, 1.73 kg of a hexane solution (diethylzinc concentration: 50% by weight) of diethylzinc and 1.02 kg of hexane were added, and the mixture was agitated. Then, the mixture was cooled down to 50° C., and a mixed solution of 0.78 kg of 3,4,5-trifluorophenol with 1.44 kg of toluene was added drop-wise to the mixture over 60 minutes at 5° C. maintained. After completion of the drop-wise addition, the mixture was agitated at 5° C. for one hour, and then was heated up to 40° C., and was agitated at 40° C. for one hour. Then, the mixture was cooled down to 22° C., and 0.11 kg of water was added drop-wise to the mixture over 1.5 hour at 22° C. maintained. After completion of the drop-wise addition, the mixture was agitated at 22° C. for 1.5 hour, and then was heated up to 40° C., and was agitated at 40° C. for two hours, and then was further heated up to 80° C., and was agitated at 80° C. for two hours. After the agitation, the supernatant of the mixture was extracted at room temperature until 16 liters of the mixture remained, and 11.6 kg of toluene was added to the remaining mixture. Next, the resultant mixture was heated up to 95° C., and was agitated for four hours. After the agitation, the supernatant of the mixture was extracted at room temperature, thereby obtaining a solid product. The obtained solid product was washed four times with each 20.8 kg of toluene, and was further washed three times with each 24 liters of hexane. Then, the washed solid product was dried, thereby obtaining a solid catalyst component (B).

### (2) Polymerization

A 3-liter inner volume autoclave equipped with an agitator was dried under reduced pressure, and was purged with argon, and then was evacuated. Hydrogen was added to the autoclave in its partial pressure of 0.065 MPa, and 50g of 1-butene and 700 g of butane as a polymerization solvent were added thereto, and then the mixture was heated up to 70° C. Then, ethylene was added thereto in its partial pressure of 1.6 MPa, thereby stabilizing the system. The system was found by gas chromatography analysis to have a gas composition of 3.69% by mol of hydrogen and 2.09% by mol of 1-butene. There was added thereto 0.9 ml of a hexane solution (concentration: 1 mol/liter) of triisobutylaluminum (organoaluminum compound (C)). Next, there were added thereto 0.5 ml of a toluene solution (concentration: 2 μmol/ml) of racemic ethylenebis(1-indenyl)zirconium diphenoxide [corresponding to component (A1)], and 0.5 ml of a toluene solution (concentration: 2 μmol/ml) of diphenylmethylene(cyclopentadienyl)(9-fluorenyl)zirconium dichloride [corresponding to component (A2)], and then 21.8 mg of the solid catalyst component (B) obtained in the above Example 1(1) was added thereto. Polymerization was carried out at 70° C. for 60 minutes, during which a mixed gas of ethylene with hydrogen (hydrogen concentration: 0.58% by mol) was continuously added thereto so as to keep the total pressure and a hydrogen concentration in the gas phase constant. Then, butane, ethylene and hydrogen were purged, thereby obtaining 85 g of an ethylene-1-butene copolymer. Properties thereof are shown in Table 1.

### EXAMPLE 2

### (1) Polymerization

A 3-liter inner volume autoclave equipped with an agitator was dried under reduced pressure, and was purged with argon, and then was evacuated. Hydrogen was added to the autoclave in its partial pressure of 0.025 MPa, and 55 g of 1-butene and 695 g of butane as a polymerization solvent were added thereto, and then the mixture was heated up to 70° C. Then, ethylene was added thereto in its partial pressure of 1.6 MPa, thereby stabilizing the system. The system was found by gas chromatography analysis to have a gas composition of 1.25% by mol of hydrogen and 3.04% by mol of 1-butene. There was added thereto 0.9 ml of a hexane solution (concentration: 1 mol/liter) of triisobutylaluminum (organoaluminum compound (C)). Next, there were added thereto 0.25 ml of a toluene solution (concentration: 2 μmol/ml) of racemic ethylenebis(1-indenyl)zirconium diphenoxide [corresponding to component (A1)], and 0.25 ml of a toluene solution (concentration: 1 μmol/ml) of diphenylmethylene(cyclopentadienyl)(9-fluorenyl)zirconium dichloride [corresponding to component (A2)], and then 5.8 mg of the solid catalyst component (B) obtained in the above Example 1(1) was added thereto. Polymerization was carried out at 70° C. for 60 minutes, during which a mixed gas of ethylene with hydrogen (hydrogen concentration: 0.30% by mol) was continuously added thereto so as to keep the total pressure and a hydrogen concentration in the gas phase constant. Then, butane, ethylene and hydrogen were purged, thereby obtaining 136 g of an ethylene-1-butene copolymer. Properties thereof are shown in Table 1.

### EXAMPLE 3

### (1) Polymerization

A 3-liter inner volume autoclave equipped with an agitator was dried under reduced pressure, and was purged with argon, and then was evacuated. Hydrogen was added to the autoclave in its partial pressure of 0.028 MPa, and 55 g of 1-butene and 695 g of butane as a polymerization solvent were added thereto, and then the mixture was heated up to 70° C. Then, ethylene was added thereto in its partial pressure of 1.6 MPa, thereby stabilizing the system. The system was found by gas chromatography analysis to have a gas composition of 1.34% by mol of hydrogen and 2.31% by mol of 1-butene. There was added thereto 0.9 ml of a hexane solution (concentration: 1 mol/liter) of triisobutylaluminum (organoaluminum compound (C)). Next, there were added thereto 0.5 ml of a toluene solution (concentration: 2 μmol/ml) of racemic ethylenebis(1-indenyl)zirconium diphenoxide [corresponding to component (A1)], and 1.0 ml of a toluene solution (concentration: 0.1 μmol/ml) of diphenylmethylene(cyclopentadienyl)(9-fluorenyl)zirconium dichloride [corresponding to component (A2)], and then 10.1 mg of the solid catalyst component (B) obtained in the above Example 1 (1) was added thereto. Polymerization was carried out at 70° C. for 60 minutes, during which a mixed gas of ethylene with hydrogen (hydrogen concentration: 0.38% by mol) was continuously added thereto so as to keep the total pressure and a hydrogen concentration in the gas phase constant. Then, butane, ethylene and hydrogen were purged, thereby obtaining 105 g of an ethylene-1-butene copolymer. Properties thereof are shown in Table 1.

### EXAMPLE 4

### (1) Preparation of Pre-Polymerized Catalyst Component

To a 5-liter inner volume autoclave equipped with an agitator, which had been previously purged with nitrogen, 835 g of butane was supplied, and the autoclave was heated up to 50° C., then 60 mg of diphenylmethylene(cyclopentadienyl)(9-fluorenyl)zirconium dichloride [corresponding to component (A2)] and 0.68 g of racemic ethylenebis(1-indenyl)zirconium diphenoxide [corresponding to component (A1)] were added thereto in a powder state, and the resultant mixture was agitated at 50° C. for 75 minutes. Next, 28 g of ethylene was fed thereto. After the system was stabilized, 10.6 g of the solid catalyst component obtained in the above Example 1(1) was added thereto, and then 4.2 ml of a heptane solution (concentration: 1 mmol/ml) of triisobutylaluminum was added thereto, thereby initiating polymerization. Pre-polymerization was carried out at 50° C. for 100 minutes, during which a mixed gas of ethylene with hydrogen (hydrogen concentration: 0.2%) was continuously added thereto. After completion of the polymerization, ethylene, butane and hydrogen were purged, and the remaining solid was dried at room temperature, thereby obtaining pre-polymerized catalyst component containing 16.5 g of polyethylene per one gram of the solid catalyst component.

### (2) Polymerization

A 5-liter autoclave equipped with an agitator was dried under reduced pressure, and was purged with argon, and then was evacuated. Hydrogen was added to the autoclave in its partial pressure of 0.029 MPa, and 200 ml of 1-hexene and 1,065 g of butane were supplied thereto. Temperature in the system was raised up to 70° C. Ethylene was added thereto in its partial pressure of 1.6 MPa, thereby stabilizing the system. The system was found by gas chromatography analysis to have a gas composition of 1.81% by mol of hydrogen. There was added thereto 2.0 ml of a heptane solution (concentration: 1 mmol/ml) of triisobutylaluminum. Next, 311 mg of the pre-polymerized catalyst component was supplied thereto. Polymerization was carried out at 70° C. for 180 minutes, during which a mixed gas of ethylene with hydrogen (hydrogen concentration: 0.32% by mol) was continuously added thereto so as to keep the total pressure and a hydrogen concentration in the gas phase constant. Then, butane, ethylene and hydrogen were purged, thereby obtaining 142 g of an ethylene-1-hexene copolymer. Properties thereof are shown in Table 1.

### EXAMPLE 5

### (1) Polymerization

A 3-liter inner volume autoclave equipped with an agitator was dried under reduced pressure, and was purged with argon, and then was evacuated. Hydrogen was added to the autoclave in its partial pressure of 0.023 MPa, and 55 g of 1-butene and 695 g of butane as a polymerization solvent were added thereto, and then the mixture was heated up to 70° C. Then, ethylene was added thereto in its partial pressure of 1.6 MPa, thereby stabilizing the system. The system was found by gas chromatography analysis to have a gas composition of 1.20% by mol of hydrogen and 2.49% by mol of 1-butene. There was added thereto 0.9 ml of a hexane solution (concentration: 1 mol/liter) of triisobutylaluminum (organoaluminum compound (C)). Next, there were added thereto 0.25 ml of a toluene solution (concentration: 2 μmol/ml) of racemic ethylenebis(1-indenyl)zirconium diphenoxide [corresponding to component (A1)], and 0.25 ml of a toluene solution (concentration: 0.1 μmol/ml) of diphenylmethylene(cyclopentadienyl)(9-fluorenyl)zirconium dichloride [corresponding to component (A2)], and then 6.3 mg of the solid catalyst component (B) obtained in the above Example 1(1) was added thereto. Polymerization was carried out at 70° C. for 60 minutes, during which a mixed gas of ethylene with hydrogen (hydrogen concentration: 0.29% by mol) was continuously added thereto so as to keep the total pressure and a hydrogen concentration in the gas phase constant. Then, butane, ethylene and hydrogen were purged, thereby obtaining 31 g of an ethylene-1-butene copolymer. Properties thereof are shown in Table 1.

### EXAMPLE 6

A 3-liter inner volume autoclave equipped with an agitator was dried under reduced pressure, and was purged with argon, and then was evacuated. Hydrogen was added to the autoclave in its partial pressure of 0.025 MPa, and 55 g of 1-butene and 695 g of butane as a polymerization solvent were added thereto, and then the mixture was heated up to 70° C. Then, ethylene was added thereto in its partial pressure of 1.6 MPa, thereby stabilizing the system. The system was found by gas chromatography analysis to have a gas composition of 1.08% by mol of hydrogen and 2.48% by mol of 1-butene. There was added thereto 0.9 ml of a hexane solution (concentration: 1 mol/liter) of triisobutylaluminum (organoaluminum compound (C)). Next, there were added thereto 0.5 ml of a toluene solution (concentration: 2 μmol/ml) of racemic ethylenebis(1-indenyl)zirconium diphenoxide [corresponding to component (A1)], and 0.25 ml of a toluene solution (concentration: 0.1 μmol/ml) of diphenylmethylene(cyclopentadienyl)(9-fluorenyl)zirconium dichloride [corresponding to component (A2)], and then 10.0 mg of the solid catalyst component (B) obtained in the above Example 1(1) was added thereto. Polymerization was carried out at 70° C. for 60 minutes, during which a mixed gas of ethylene with hydrogen (hydrogen concentration: 0.33% by mol) was continuously added thereto so as to keep the total pressure and a hydrogen concentration in the gas phase constant. Then, butane, ethylene and hydrogen were purged, thereby obtaining 112 g of an ethylene-1-butene copolymer. Properties thereof are shown in Table 1.

### EXAMPLE 7

### (1) Polymerization

A 3-liter inner volume autoclave equipped with an agitator was dried under reduced pressure, and was purged with argon, and then was evacuated. Hydrogen was added to the autoclave in its partial pressure of 0.022 MPa, and 55 g of 1-butene and 695 g of butane as a polymerization solvent were added thereto, and then the mixture was heated up to 70° C. Then, ethylene was added thereto in its partial pressure of 1.6 MPa, thereby stabilizing the system. The system was found by gas chromatography analysis to have a gas composition of 1.12% by mol of hydrogen and 3.10% by mol of 1-butene. There was added thereto 0.9 ml of a hexane solution (concentration: 1 mol/liter) of triisobutylaluminum (organoaluminum compound (C)). Next, there were added thereto 0.5 ml of a toluene solution (concentration: 2 μmol/ml) of racemic ethylenebis(1-indenyl)zirconium diphenoxide [corresponding to component (A1)], and 1.0 ml of a toluene solution (concentration: 0.02 μmol/ml) of diphenylmethylene(cyclopentadienyl)(9-fluorenyl)zirconium dichloride [corresponding to component (A2)], and then 10.0 mg of the solid catalyst component (B) obtained in the above Example 1(1) was added thereto. Polymerization was carried out at 70° C. for 60 minutes, during which a mixed gas of ethylene with hydrogen (hydrogen concentration: 0.36% by mol) was continuously added thereto so as to keep the total pressure and a hydrogen concentration in the gas phase constant. Then, butane, ethylene and hydrogen were purged, thereby obtaining 150 g of an ethylene-1-butene copolymer. Properties thereof are shown in Table 1.

### EXAMPLE 8

### (1) Preparation of Pre-Polymerized Catalyst Component

To a 5-liter inner volume autoclave equipped with an agitator, which had been previously purged with nitrogen, 835 g of butane was supplied, and the autoclave was heated up to 50° C., then 10 mg of diphenylmethylene(cyclopentadienyl)(9-fluorenyl)zirconium dichloride [corresponding to component (A2)] and 0.72 g of racemic ethylenebis(1-indenyl)zirconium diphenoxide [corresponding to component (A1)] were added thereto in a powder state, and the resultant mixture was agitated at 50° C. for 75 minutes. Next, 28 g of ethylene was fed thereto. After the system was stabilized, 10.4 g of the solid catalyst component obtained in the above Example 1(1) was added thereto, and then 4.1 ml of a heptane solution (concentration: 1 mmol/ml) of triisobutylaluminum was added thereto, thereby initiating polymerization. Pre-polymerization was carried out at 50° C. for 100 minutes, during which a mixed gas of ethylene with hydrogen (hydrogen concentration: 0.2%) was continuously added thereto. After completion of the polymerization, ethylene, butane and hydrogen were purged, and the remaining solid was dried at room temperature, thereby obtaining pre-polymerized catalyst component containing 18.7 g of polyethylene per one gram of the solid catalyst component.

### (2) Polymerization

A 5-liter autoclave equipped with an agitator was dried under reduced pressure, and was purged with argon, and then was evacuated. Hydrogen was added to the autoclave in its partial pressure of 0.029 MPa, and 200 ml of 1-hexene and 1,065 g of butane were supplied thereto. Temperature in the system was raised up to 70° C. Ethylene was added thereto in its partial pressure of 1.6 MPa, thereby stabilizing the system. The system was found by gas chromatography analysis to have a gas composition of 1.67% by mol of hydrogen. There was added thereto 2.0 ml of a heptane solution (concentration: 1 mmol/ml) of triisobutylaluminum. Next, 324 mg of the pre-polymerized catalyst component was supplied thereto. Polymerization was carried out at 70° C. for 160 minutes, during which a mixed gas of ethylene with hydrogen (hydrogen concentration: 0.32% by mol) was continuously added thereto so as to keep the total pressure and a hydrogen concentration in the gas phase constant. Then, butane, ethylene and hydrogen were purged, thereby obtaining 146 g of an ethylene-1-hexene copolymer. Properties thereof are shown in Table 1.

### EXAMPLE 9

### (1) Polymerization

A 5-liter autoclave equipped with an agitator was dried under reduced pressure, and was purged with argon, and then was evacuated. Hydrogen was added to the autoclave in its partial pressure of 0.051 MPa, and 200 ml of 1-hexene and 1,065 g of butane were supplied thereto. Temperature in the system was raised up to 70° C. Ethylene was added thereto in its partial pressure of 1.6 MPa, thereby stabilizing the system. The system was found by gas chromatography analysis to have a gas composition of 2.61% by mol of hydrogen. Next, 1.0 ml of a toluene solution (concentration: 0.1 mmol/ml) of triethylamine was added thereto. There was added thereto 2.0 ml of a heptane solution (concentration: 1 mmol/ml) of triisobutylaluminum. Next, 406 mg of the pre-polymerized catalyst component prepared in above Example 8(1) was supplied thereto. Polymerization was carried out at 70° C. for 170 minutes, during which a mixed gas of ethylene with hydrogen (hydrogen concentration: 0.49% by mol) was continuously added thereto so as to keep the total pressure and a hydrogen concentration in the gas phase constant. Then, butane, ethylene and hydrogen were purged, thereby obtaining 162 g of an ethylene-1-hexene copolymer. Properties thereof are shown in Table 1.

### EXAMPLE 10

### (1) Polymerization

A 3-liter inner volume autoclave equipped with an agitator was dried under reduced pressure, and was purged with argon, and then was evacuated. Hydrogen was added to the autoclave in its partial pressure of 0.022 MPa, and 55 g of 1-butene and 695 g of butane as a polymerization solvent were added thereto, and then the mixture was heated up to 70° C. Then, ethylene was added thereto in its partial pressure of 1.6 MPa, thereby stabilizing the system. The system was found by gas chromatography analysis to have a gas composition of 1.19% by mol of hydrogen and 3.04% by mol of 1-butene. There was added thereto 0.9 ml of a hexane solution (concentration: 1 mol/liter) of triisobutylaluminum (organoaluminum compound (C)). Next, there were added thereto 0.25 ml of a toluene solution (concentration: 2 μmol/ml) of racemic ethylenebis(1-indenyl)zirconium diphenoxide [corresponding to component (A1)], and 0.63 ml of a toluene solution (concentration: 0.01 μmol/ml) of diphenylmethylene(cyclopentadienyl)(9-fluorenyl)zirconium dichloride [corresponding to component (A2)], and then 4.5 mg of the solid catalyst component (B) obtained in the above Example 1(1) was added thereto. Polymerization was carried out at 70° C. for 60 minutes, during which a mixed gas of ethylene with hydrogen (hydrogen concentration: 0.32% by mol) was continuously added thereto so as to keep the total pressure and a hydrogen concentration in the gas phase constant. Then, butane, ethylene and hydrogen were purged, thereby obtaining 94 g of an ethylene-1-butene copolymer. Properties thereof are shown in Table 1.

### EXAMPLE 11

### (1) Polymerization

A 3-liter inner volume autoclave equipped with an agitator was dried under reduced pressure, and was purged with argon, and then was evacuated. Hydrogen was added to the autoclave in its partial pressure of 0.022 MPa, and 55 g of 1-butene and 695 g of butane as a polymerization solvent were added thereto, and then the mixture was heated up to 70° C. Then, ethylene was added thereto in its partial pressure of 1.6 MPa, thereby stabilizing the system. The system was found by gas chromatography analysis to have a gas composition of 1.07% by mol of hydrogen and 3.36% by mol of 1-butene. There was added thereto 0.9 ml of a hexane solution (concentration: 1 mol/liter) of triisobutylaluminum (organoaluminum compound (C)). Next, there were added thereto 0.5 ml of a toluene solution (concentration: 2 μmol/ml) of racemic ethylenebis(1-indenyl)zirconium diphenoxide [corresponding to component (A1)], and 1.3 ml of a toluene solution (concentration: 0.01 μmol/ml) of diphenylmethylene(cyclopentadienyl)(9-fluorenyl)zirconium dichloride [corresponding to component (A2)], and then 8.9 mg of the solid catalyst component (B) obtained in the above Example 1 (1) was added thereto. Polymerization was carried out at 70° C. for 60 minutes, during which a mixed gas of ethylene with hydrogen (hydrogen concentration: 0.36% by mol) was continuously added thereto so as to keep the total pressure and a hydrogen concentration in the gas phase constant. Then, butane, ethylene and hydrogen were purged, thereby obtaining 143 g of an ethylene-1-butene copolymer. Properties thereof are shown in Table 1.

### EXAMPLE 12

### (1) Polymerization

A 3-liter inner volume autoclave equipped with an agitator was dried under reduced pressure, and was purged with argon, and then was evacuated. Hydrogen was added to the autoclave in its partial pressure of 0.022 MPa, and 55 g of 1-butene and 695 g of butane as a polymerization solvent were added thereto, and then the mixture was heated up to 70° C. Then, ethylene was added thereto in its partial pressure of 1.6 MPa, thereby stabilizing the system. The system was found by gas chromatography analysis to have a gas composition of 1.19% by mol of hydrogen and 2.92% by mol of 1-butene. There was added thereto 0.9 ml of a hexane solution (concentration: 1 mol/liter) of triisobutylaluminum (organoaluminum compound (C)). Next, there were added thereto 0.5 ml of a toluene solution (concentration: 2 μmol/ml) of racemic ethylenebis(1-indenyl)zirconium diphenoxide [corresponding to component (A1)], and 1.2 ml of a toluene solution (concentration: 0.01 μmol/ml) of diphenylmethylene(cyclopentadienyl)(9-fluorenyl)zirconium dichloride [corresponding to component (A2)], and then 8.9 mg of the solid catalyst component (B) obtained in the above Example 1(1) was added thereto. Polymerization was carried out at 70° C. for 60 minutes, during which a mixed gas of ethylene with hydrogen (hydrogen concentration: 0.36% by mol) was continuously added thereto so as to keep the total pressure and a hydrogen concentration in the gas phase constant. Then, butane, ethylene and hydrogen were purged, thereby obtaining 72 g of an ethylene-1-butene copolymer. Properties thereof are shown in Table 1.

### COMPARATIVE EXAMPLE 1

### (1) Polymerization

A 3-liter inner volume autoclave equipped with an agitator was dried under reduced pressure, and was purged with argon, and then was evacuated. Hydrogen was added to the autoclave in its partial pressure of 0.08 MPa, and 55 g of 1-butene and 695 g of butane as a polymerization solvent were added thereto, and then the mixture was heated up to 70° C. Then, ethylene was added thereto in its partial pressure of 1.6 MPa, thereby stabilizing the system. The system was found by gas chromatography analysis to have a gas composition of 3.68% by mol of hydrogen and 2.22% by mol of 1-butene. There was added thereto 0.9 ml of a hexane solution (concentration: 1 mol/liter) of triisobutylaluminum (organoaluminum compound (C)). Next, there were added thereto 0.5 ml of a toluene solution (concentration: 2 μmol/ml) of racemic ethylenebis(1-indenyl)zirconium diphenoxide [corresponding to component (A1)], and 1.0 ml of a toluene solution (concentration: 2 μmol/ml) of diphenylmethylene(cyclopentadienyl)(9-fluorenyl)zirconium dichloride [corresponding to component (A2)], and then 31.3 mg of the solid catalyst component (B) obtained in the above Example 1(1) was added thereto. Polymerization was carried out at 70° C. for 60 minutes, during which a mixed gas of ethylene with hydrogen (hydrogen concentration: 0.80% by mol) was continuously added thereto so as to keep the total pressure and a hydrogen concentration in the gas phase constant. Then, butane, ethylene and hydrogen were purged, thereby obtaining 121 g of an ethylene-1-butene copolymer. Properties thereof are shown in Table 1.

### COMPARATIVE EXAMPLE 2

### (1) Polymerization

A 3-liter inner volume autoclave equipped with an agitator was dried under reduced pressure, and was purged with argon, and then was evacuated. Hydrogen was added to the autoclave in its partial pressure of 0.022 MPa, and 55 g of 1-butene and 695 g of butane as a polymerization solvent were added thereto, and then the mixture was heated up to 70° C. Then, ethylene was added thereto in its partial pressure of 1.6 MPa, thereby stabilizing the system. The system was found by gas chromatography analysis to have a gas composition of 1.20% by mol of hydrogen and 3.15% by mol of 1-butene. There was added thereto 0.9 ml of a hexane solution (concentration: 1 mol/liter) of triisobutylaluminum (organoaluminum compound (C)). Next, there were added thereto 0.5 ml of a toluene solution (concentration: 2 μmol/ml) of racemic ethylenebis(1-indenyl)zirconium diphenoxide [corresponding to component (A1)], and 1.0 ml of a toluene solution (concentration: 0.01 μmol/ml) of diphenylmethylene(cyclopentadienyl)(9-fluorenyl)zirconium dichloride [corresponding to component (A2)], and then 9.4 mg of the solid catalyst component (B) obtained in the above Example 1(1) was added thereto. Polymerization was carried out at 70° C. for 60 minutes, during which a mixed gas of ethylene with hydrogen (hydrogen concentration: 0.29% by mol) was continuously added thereto so as to keep the total pressure and a hydrogen concentration in the gas phase constant. Then, butane, ethylene and hydrogen were purged, thereby obtaining 90 g of an ethylene-1-butene copolymer. Properties thereof are shown in Table.

TABLE 1

| | | Example | | | | | |
|---|---|---|---|---|---|---|---|
| | | 1 | 2 | 3 | 4 | 5 | 6 |
| Component (A1)/ | — | 1 | 2 | 10 | 13 | 20 | 40 |
| component (A2) | | | | | | | |
| Density | kg/m³ | 924 | 922 | 924 | 927 | 923 | 923 |
| MFR | g/10 minutes | 2.8 | 0.8 | 1.8 | 1.2 | 0.5 | 0.8 |
| SR | — | 2.25 | 2.29 | 1.99 | 1.90 | 1.76 | 1.60 |
| Molecular weight distribution | | | | | | | |
| Mw/Mn | — | 10.9 | 7.8 | 6.0 | 5.6 | 6.1 | 6.9 |
| Mz/Mw | | 4.4 | 4.3 | 3.4 | 3.0 | 3.4 | 3.0 |
| MT | cN | 10 | 28 | 11 | 15 | 17 | 9 |
| MTV | m/minute | 2.3 | 0.7 | 1.8 | 3.2 | 1.7 | 7.8 |
| Activation energy of flow | KJ/mol | 73 | 82 | 73 | 77 | 75 | 74 |
| Melt complex viscosity | Pa · sec | 408 | 435 | 529 | 582 | 856 | 705 |
| Impact strength | kJ/m² | 128 | 131 | 114 | 451 | 165 | 151 |
| | | Example | | | | | |
| | | 7 | 8 | 9 | 10 | 11 | 12 |
| Component (A1)/ | — | 50 | 76 | 76 | 77 | 79 | 83 |
| component (A2) | | | | | | | |
| Density | kg/m³ | 925 | 927 | 927 | 923 | 923 | 923 |
| MFR | g/10 minutes | 3.0 | 1.9 | 3.3 | 1.9 | 1.9 | 1.0 |
| SR | — | 1.74 | 1.60 | 1.58 | 1.55 | 1.59 | 1.55 |
| Molecular weight distribution | | | | | | | |
| Mw/Mn | — | 6.3 | 6.2 | 7.0 | 7.5 | 6.4 | 6.0 |
| Mz/Mw | | 2.9 | 2.6 | 2.7 | 2.9 | 2.8 | 2.7 |
| MT | cN | 4 | 5 | 3 | 5 | 5 | 7 |
| MTV | m/minute | 31.2 | 49.5 | 62.5 | 34.7 | 28.3 | 23.5 |
| Activation energy of flow | KJ/mol | 61 | 72 | 67 | 68 | 65 | 68 |
| Melt complex viscosity | Pa · sec | 534 | 631 | 488 | 683 | 617 | 828 |
| Impact strength | kJ/m² | 104 | 422 | 273 | 127 | 109 | 158 |

Comparative
Example

| | | 1 | 2 |
|---|---|---|---|
| Component (A1)/ | — | 0.5 | 95 |
| component (A2) | | | |
| Density | kg/m³ | 923 | 922 |
| MFR | g/10 minutes | 1.9 | 1.0 |
| SR | — | 2.00 | 1.50 |
| Molecular weight distribution | | | |
| Mw/Mn | — | 12.4 | 5.9 |
| Mz/Mw | | 4.1 | 2.7 |
| MT | cN | 12 | 7 |
| MTV | m/minute | 2.1 | 19.8 |
| Activation energy of flow | KJ/mol | 31 | 72 |
| Melt complex viscosity | Pa · sec | 490 | 827 |
| Impact strength | kJ/m² | 180 | 143 |

### INDUSTRIAL APPLICABILITY

According to the present invention, there can be provided a catalyst for polymerizing an olefin capable of producing olefin polymers excellent in their mechanical strength and molding processability, and a process for producing an olefin polymer by polymerizing an olefin in the presence of the above catalyst.

1. An olefin polymerization catalyst formed by contacting a transition metal compound (component (A1)) represented by the following general formula (1), a transition metal compound (component (A2)) represented by the following general formula (3) and the following solid catalyst component (component (B)) with one another, an amount of the component (A1) being 1 to 90 parts by mol per one mol of the component (A2): 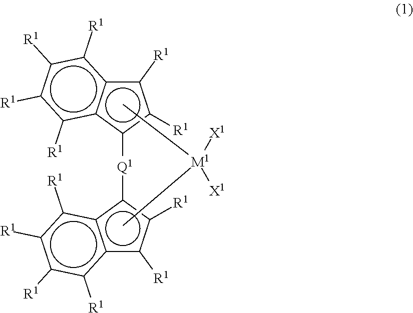
wherein M¹ is a transition metal atom of the group 4 in the periodic table; X¹ and R¹ are independently of each other a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural X¹s are the same as, or different from each other, and plural les are the same as, or different from one another; and Q₁ is a cross-linking group represented by the following general formula (2): 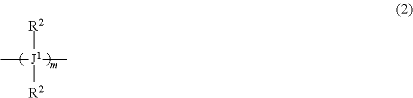
wherein m is an integer of 1 to 5; J¹ is an atom of the group 14 in the periodic table; and R² is a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural R²s are the same as, or different from one another: 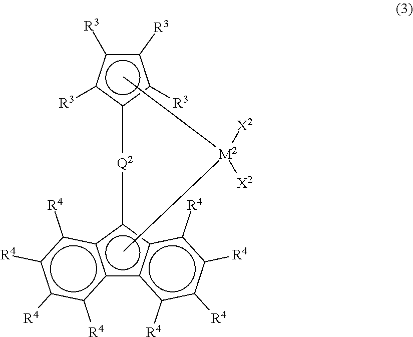
wherein M² is a transition metal atom of the group 4 in the periodic table; X², R³ and R⁴ are independently of one another a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural X²s are the same as, or different from each other, plural R³s are the same as, or different from one another, and plural R⁴s are the same as, or different from one another; and Q² is a cross-linking group represented by the following general formula (4): 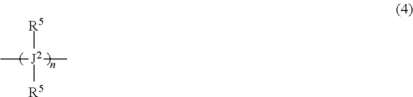
wherein n is an integer of 1 to 5; J² is an atom of the group 14 in the periodic table; and R⁵ is a hydrogen atom, a halogen atom, a hydrocarbyl group having 1 to 20 carbon atoms, and optionally having one or more substituents, a hydrocarbyloxy group having 1 to 20 carbon atoms, and optionally having one or more substituents, a substituted silyl group having 1 to 20 carbon atoms, or a substituted amino group having 1 to 20 carbon atoms, and plural R⁵s are the same as, or different from one another:
component (B) being a solid catalyst component formed by contacting a compound (component (b1)) represented by the following general formula (5), a compound (component (b2)) represented by the following general formula (6), a compound (component (b3)) represented by the following general formula (7), and a granulous carrier (component (b4)):
M³Lₓ (5)
Rₜ₋₁⁶T¹H (6)
Rₛ₋₂⁷T²H₂ (7)
wherein M³ is a lithium atom, a sodium atom, a potassium atom, a rubidium atom, a cesium atom, a beryllium atom, a magnesium atom, a calcium atom, a strontium atom, a barium atom, a zinc atom, a germanium atom, a tin atom, a lead atom, a antimony atom or a bismuth atom; x is a number corresponding to the valence of M³; L is a hydrogen atom, a halogen atom or a hydrocarbyl group optionally having one or more substituents, and when plural Ls exist, they are the same as, or different from one another; T¹ is an oxygen atom, a sulfur atom, a nitrogen atom or a phosphorus atom; t is a number corresponding to the valence of T¹; R⁶ is a halogen atom, an electron-withdrawing group, a halogen atom-containing group, or a group containing an electron-withdrawing group, and when plural R⁶s exist, they are the same as, or different from one another; T² is an oxygen atom, a sulfur atom, a nitrogen atom or a phosphorus atom; s is a number corresponding to the valence of T²; and R⁷ is a halogen atom, a hydrocarbyl group or a halogenated hydrocarbyl group.

2. The olefin polymerization catalyst according to claim 1, which is formed by contacting following further component (C) with components (A1), (A2) and (B):
component (C) organoaluminum compound.

3. A process for producing an olefin polymer, comprising the step of polymerizing an olefin in the presence of the olefin polymerization catalyst according to claim 1.

4. A process for producing an olefin polymer, comprising the step of polymerizing an olefin in the presence of the olefin polymerization catalyst according to claim 2.
